(19) United States
(12) Patent Application Publication
(10) Pub. No.: US 2005/0122047 A1
(43) Pub. Date: Jun. 9, 2005

(54) Metal halide lamp, metal halide lamp operating device, and headlamp device for automobiles

(76) Inventors: Hiroyuki Kato, Yokosuka-shi (JP); Hiromichi Kawashima, Yokosuka-shi (JP); Sakae Katayama, Yokosuka-shi (JP); Shigekatsu Yasunaga, Yokosuka-shi (JP); Kozo Uemura, Yokosuka-shi (JP); Toshihiko Ishigami, Yokosuka-shi (JP); Mikio Matsuda, Yokosuka-shi (JP); Toshio Hiruta, Yokosuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/490,894

(22) PCT Filed: Sep. 26, 2002
(86) PCT No.: PCT/JP02/09916

(30) Foreign Application Priority Data
Sep. 28, 2001 (JP) 2001-304511
Oct. 23, 2001 (JP) 2001-324444
Oct. 23, 2001 (JP) 2001-325202

(51) Int. Cl. H01J 61/12; H01J 29/96

(52) U.S. Cl. 313/631; 315/77; 315/60; 313/640

(57) ABSTRACT

The present invention relates to a metal halide lamp substantially containing no mercury, a metal halide lamp lighting device using the same and an automotive headlamp apparatus using the same. And object of the invention is to provide such products in which a rapid rising of luminous flux is achieved. A metal halide lamp (MHL) according to the present invention has: a discharge vessel having an inner volume of C (cc) and having a pair of electrodes (2), (2) sealed in a hermetic vessel (1a) at opposite ends of a discharge space (1a) in the hermetic vessel (1a) at a distance of 5 mm or less; and a discharge medium containing xenon gas at 3 atmospheres or higher, a halide of sodium Na, and at least one of halides of scandium Sc and rare earth metals, the melting point of the halides being T (K), in which a lamp power in a stable state is 50 W or lower, and the formula (1) is satisfied:
(H/C)×[R/(T/500)⁶]<3.11 (1), where the amount of the halide deposited on the electrodes when the lamp is off is H (mg), and the ratio of a maximum lamp power at the start of lighting to the lamp power in the stable state is R.

### TECHNICAL FIELD

The present invention relates to a metal halide lamp substantially containing no mercury, a metal halide lamp lighting device using the same, and an automotive headlamp apparatus using the same.

### BACKGROUND ART

Metal halide lamps which have a hermetic vessel with a pair of opposing electrodes containing an inert gas, a halide of a light-emitting metal and mercury in the vessel are used widely because of their relatively high efficiency and good color rendering. Such metal halide lamps have become widely used also as automotive headlamps. Including those used as the automotive headlamps, the metal halide lamps currently in practical use essentially uses mercury (conveniently referred to as a mercury-containing lamp, hereinafter). In Japanese Patent Laid-Open No. 2-7347, there is described an exemplary specification of a metal halide lamp used as the automotive headlamp, which specifies that about 2-15 mg of mercury has to be sealed. Besides, in Japanese Patent Laid-Open No. 59-111244, there is described a discharge lamp, that is, a metal halide lamp, suitable for the automotive headlamp which contains mercury in a predetermined amount prescribed. According to the description, when this metal halide lamp operates in a horizontal position, the discharge arc shrinks to be at least substantially linear, and the metal halide lamp is efficient.

However, nowadays environmental issues are becoming serious, and in the illuminating industry, it is considered highly important to reduce or even eliminate mercury in lamps, which applies a significant load to the environment.

To address this problem, several approaches to eliminate mercury in the metal halide lamp have been already proposed. For example, the inventors have made the inventions described in Japanese Patent No. 2982198 and Japanese Patent Laid-Open Nos. 6-84496 and 11-238488. The first invention is a metal halide lamp which has a halide of scandium Sc or a rare earth metal and an inert gas sealed therein and is controllably turned on and off by a pulse current. The second invention is a metal halide lamp which contains a discharge medium constituted by a metal halide and an inert gas and thus has a less variable color characteristic over a wide input range, thereby being capable of dimming illumination. The third invention is a metal halide lamp which is improved in electrical characteristic by containing, in addition to a first metal halide, which is a primary light-emitting material, a second metal halide, which has a high vapor pressure and is hard to emit light.

Furthermore, in Japanese Patent Laid-Open No. 11-307048, there is described a metal halide lamp which avoids blackening due to scattering of the electrodes by containing, in addition to the halides of scandium Sc and sodium Na, the halides of yttrium Y and indium In as third metal halides which have a vapor pressure of 1×10⁻⁵ atmospheres in operation and whose metals themselves are ionized at 5 -10 eV. The metal halide lamp according to the invention disclosed in this document is described as having any luminous flux and chromaticity range required for the automotive headlamp.

FIG. 13 is an enlarged view of an essential part of a conventional mercury-containing lamp turned off. In this drawing, reference numeral 101 denotes a hermetic vessel, reference numeral 102 denotes an electrode, and reference numeral 103 denotes a halide.

The discharge vessel 101 comprises a hermetic vessel 101a and a pair of electrodes 101b, and a significant amount of halide 104 is deposited on shaft parts of the electrodes 101b.

In the case of a mercury-containing lamp for an automotive headlamp, xenon primarily emits light immediately after the lamp is turned on, and then, mercury is vaporized quickly and abruptly to begin to emit light. Since the efficiency of light emission of mercury is several times higher than that of xenon, 80% or higher of a rated luminous flux is achieved 4 seconds after the turn-on of the lamp, and thus, relatively rapid rising of luminous flux is achieved. The luminous flux described above can be attained by inputting a power about twice as high as a rated lamp power, that is, a lamp power in a stable state immediately after the turn-on of the lamp. A maximum lamp current flows only immediately after the turn-on of the lamp, and the lamp current decreases abruptly in 1-2 seconds after the turn-on and is equal to or lower than a half of the maximum current after 4 seconds.

On the other hand, in the case of a metal halide lamp substantially containing no mercury (conveniently referred to as a mercury-free lamp hereinafter) used as an automotive headlamp, xenon emits light immediately after the lamp is turned on, as with the mercury-containing lamp. Then, however, the halide is not sufficiently vaporized before the temperature thereof rises to about 400-600° C., and this takes about 4 seconds after the turn-on of the lamp is started. Therefore, xenon continues to emit light for the meanwhile. Thus, there is a problem that the rising of luminous flux of the mercury-free lamp achieved with a lamp power is inferior to that of the mercury-containing lamp, and a current close to the maximum lamp current has to be flown for about 4 seconds after the lamp is turned on, as shown in FIG. 1.

FIG. 1 is a graph showing variations of lamp currents of a mercury-free lamp and a mercury-containing lamp after the lamps are turned on. FIG. 2 is a graph showing variations of electrode temperatures thereof, and FIG. 3 is a graph showing variations of vapor pressures thereof. In the drawings, the horizontal axis indicates time (second), and the vertical axis in FIG. 1 indicates lamp current, the vertical axis in FIG. 2 indicates electrode temperature, and FIG. 3 indicates vapor pressure of the halide and mercury, all the vertical axes indicating relative values. In the drawings, the curves A are for the mercury-free lamp, and the curves B are for the mercury-containing lamp.

As described above, the mercury-free lamp used as an automotive headlamp is temporarily supplied with a relatively high lamp current when it is turned on to provide a rapid rising of luminous flux. Thus, as shown in FIG. 4, it emits an instantaneous intense light exhibiting orange for about 0.2 to 2 seconds after the turn-on.

FIG. 4 is a graph showing rising characteristics of luminous flux of a conventional mercury-free lamp and a mercury-free lamp according to the present invention at the time of turn-on. In this drawing, the horizontal axis indicates time (after turn-on) (second), and the vertical axis indicates rising ratio of luminous flux (%). In this drawing, the curve C is for the present invention, and the curve D is for the conventional mercury-free lamp such as one shown in FIG. 13. The mercury-free lamp according to the present invention will be described later.

The instantaneous and short-duration intense light emitted immediately after the turn-on of the lamp has a luminance several times higher than the light emitted in a stable state and often exhibits orange due to Na, which is easy to emit light. However, the light may exhibit various colors because it may contain light emitted by Sc or another metal. When the metal halide lamp is used as an automotive headlamp, such light emission is not preferred in terms of safety, and thus, has to be suppressed.

To the contrary, in the mercury-containing lamp, the intense light emission immediately after the turn-on thereof described above does not occur, or, if any, occurs for an extremely short time, leading to no practical problem.

An object of the present invention is to provide a metal halide lamp suitable for use as an automotive headlamp which substantially contains no mercury out of consideration to the environment and is improved in rising of luminous flux, a metal halide lamp lighting device using the same and an automotive headlamp apparatus using the same.

Another object of the present invention is to provide the products described above in which an instantaneous intense light emission in 2 seconds after the turn-on is suppressed.

Another object of the present invention is to provide the products described above which are improved in efficiency of light emission without loss of life.

Another object of the present invention is to provide the products described above in which discharge is stabilized.

Another object of the present invention is to provide the. products described above having a desired light distribution.

Another object of the present invention is to provide the products described above which are improved in reliability.

Another object of the present invention is to provide the products described above which are improved in reliability by reducing wear of electrodes to suppress the occurrence of various defects due to the wear of the electrodes.

### DISCLOSURE OF THE INVENTION

A metal halide lamp according to the embodiment described in claim 1 is characterized in that the metal halide lamp comprises: a discharge vessel having a hermetic vessel which is fire resistant and translucent and has a discharge space therein, and a pair of electrodes provided at opposite ends of the discharge space in the hermetic vessel with facing each other at a distance of 5 mm or less, the inner volume of the hermetic vessel being C in terms of cc; and a discharge medium substantially containing no mercury, sealed in the hermetic vessel, and containing xenon at 3 atmospheres or higher, a halide of sodium Na, and at least one of halides of scandium Sc and rare earth metals, the melting point of the halides being T in terms of K, in a stable state, the metal halide lamp is kept on with a. lamp power of 50 W or lower, and the formula (1) is satisfied:
(H/C)×[R/(T/500)⁶]<3.11 (1),

where the amount of the halide deposited on the electrodes when the lamp is off is denoted by H in terms of mg, and the ratio of a maximum lamp power at the start of lighting to the lamp power in the stable state is denoted by R.

Terms used in this embodiment and the embodiments described later have definitions and technical meanings as follows unless otherwise specified. In the present invention, the discharge vessel, the discharge medium and the like are essential components. In the following, each component will be described.

<Discharge Vessel>

The discharge vessel comprises a hermetic vessel and a pair of electrodes.

(Hermetic Vessel)

The hermetic vessel is fire resistant and translucent and has a discharge space formed therein. The words “fire resistance” mean that the hermetic vessel can adequately withstand a normal operating temperature of the metal halide lamp. Therefore, the hermetic vessel may be made of any material as far as it has a fire resistance and can allow the visible light in a desired wavelength range produced by discharge to be emitted to the outside. For example, the hermetic vessel may be made of a ceramic, such as quartz glass, translucent alumina and YAG, or a single crystal thereof. As required, the inner surface of the hermetic vessel may be coated with a transparent film having a halogen resistance or halide resistance, or may be modified.

The discharge space formed in the hermetic vessel preferably has an elongated shape. For example, it has a cylindrical, spheroidal or spindle shape.

Furthermore, a part of the hermetic vessel which surrounds the discharge space can have a relatively high thickness. That is, a part of the hermetic vessel around the middle of the distance between the electrodes can be thicker than the end parts thereof. This enhances heat transfer of the hermetic vessel, whereby the temperature of the halide adhering to the inner surface of the lower part and side part of the discharge space of the hermetic vessel increases rapidly. Thus, a rapid rising of luminous flux is attained.

(A Pair of Electrodes)

The pair of electrodes is sealed at opposite ends of the discharge space in the hermetic vessel with facing each other at a distance of 5 mm or less. The electrodes may be made of tungsten, doped tungsten, rhenium, a rhenium/tungsten alloy or the like, have an elongated rod shape, and be supported with the base end parts thereof being embedded in the ends of the hermetic vessel and the tip end parts thereof protruding into the hermetic vessel. In the case of a metal halide lamp for an automotive headlamp, as desired, the electrodes can have a maximum-diameter section thicker than the shaft part thereof at a short distance from the tip ends thereof. That is, the lamp is turned on and off highly frequently, and a lamp current higher than that in a stable state flows at the start of lighting. If the diameter of the electrodes is entirely increased, a crack is likely to occur in the parts of the hermetic vessel in contact with the shaft parts of the electrodes because the parts are subject to thermal stress each time the lamp is turned on and off. If the maximum-diameter sections are provided near the tip ends of the electrodes as described above, the shaft parts of the electrodes are not increased in diameter, and therefore, a crack is hard to occur.

Furthermore, the electrodes may be configured for an alternating current or direct current. If the lamp is operated by an alternating current, the electrodes of the pair have the same structure. If the lamp is operated by a direct current, in general, the temperature of the anode increases rapidly. Thus, if the maximum-diameter section is formed on the anode at a short distance from the tip end, the heat radiating area can be increased, and thus, the anode can be ready for a frequent on/off operation. To the contrary, the cathode may not have the maximum-diameter section.

Furthermore, the electrodes are supported by being embedded in the hermetic vessel and are externally supplied with power through a conductive means hermetically introduced into the hermetic vessel. In the case where the hermetic vessel is made of quartz glass, the conductive means may be a well-known sealed metal foil. Specifically, as the sealed metal foil, a foil of molybdenum or the like is hermetically embedded in the sealing part of the hermetic vessel with one end being welded to the base end of the electrode and the other end being welded to the tip end of the externally introduced line. The sealed metal foil can be hermetically embedded in a known sealing manner, such as chip-less decompression sealing or pinch sealing.

<Discharge Medium>

The discharge medium contains a halide and an inert gas and substantially contains no mercury.

(Halide)

The halides include, as halides of light-emitting metals, at least a halide of sodium Na and at least one of halides of scandium Sc and rare earth metals. Preferably, the halide of the light-emitting metal constitutes a first halide, and a second metal halide described later is added thereto.

Sodium Na, scandium Sc and rare earth metals described above are highly efficient light emitting material, and sodium Na and/or scandium Sc and rare earth metals is a primary light-emitting metal in this invention. However, as required, a halide of another light-emitting metal, such as In, can be added for color adjustment, for example. In the case where a halide of Zn is used as the second metal halide described later, Zn provides color adjustment because Zn emits blue light.

Now, a case where the second metal halide is added will be described. The second metal halide is characterized by a high vapor pressure. Thus, it is sealed as a discharge medium primarily to provide a lamp voltage. The second metal halide is preferably one or more selected among from halides of Mg, Co, Cr, Zn, Mn, Sb, Re, Ga, Sn, Fe, Al, Ti, Zr And Hf. By using the second metal halide instead of mercury, a lamp voltage of about 25 to 70 V can be achieved in the metal halide lamp which has the electrodes at a distance of 5 mm or less and has a lamp power of 50 W or lower.

Besides the relatively high vapor pressure, the second metal halide has a characteristic that it emits a relatively little visible light. However, this is not very important in this invention.

Thus, sealing the second metal halide in addition to the first metal halide in the hermetic vessel can increase the lamp voltage so as to fall within a desired range, and therefore, a required lamp power can be input with a relatively low lamp current.

Now, a halogen of a halide will be described. That is, in terms of reactivity, iodine is the most suitable. At least the primary light-emitting metal described above is sealed in the hermetic vessel in the form of an iodide. However, as required, different compounds of halogens, for example iodide and bromide, may be used together.

Furthermore, the halide is sealed in the hermetic vessel in an excessive amount, and an excess of the halide, which is not evaporated, remains as the liquid phase and adheres to the inner wall of the bottom part and side part of the discharge space when the lamp is on.

(Xenon)

Xenon gas serves as a starting gas and a buffer gas and serves also to dominantly emit light immediately after the lamp is turned on. The pressure of the sealed xenon gas is 3 atmospheres or higher, preferably is at 5 atmospheres or higher and most preferably falls within a range from 9 to 16 atmospheres. Therefore, even if the vapor pressure of the halides is low for a several seconds after the lamp is turned on, the lamp voltage of the metal halide lamp can be maintained as high as possible. Thus, a higher lamp power can be provided with a same lamp current, and the rising characteristics of luminous flux can be improved. The good rising characteristics of luminous flux, which are advantageous for any use of the lamp, are extremely important particularly in applications of automotive headlamp, liquid-crystal projector and the like.

(Mercury)

The words “substantially contain no mercury” in this invention mean that mercury is not sealed at all or that mercury may exist in an amount of less than 2 mg/cc of the inner volume of the hermetic vessel, preferably 1 mg/cc of the inner volume of the hermetic vessel or less. However, from an environmental point of view, it is desirable that no mercury is sealed. If the electrical characteristics of the discharge lamp are maintained by a mercury vapor as in the prior art, the mercury has to be sealed in the hermetic vessel in an amount of 20 to 40 mg/cc, possibly 50 mg/cc, of the inner volume of the hermetic vessel in the case of a short arc type metal halide lamp. Compared with this, the amount of mercury used in this invention is significantly reduced. <Lamp Power Immediately After the Lamp is Turned on>

According to this invention, a period in which a power two or more times higher than the lamp power in the stable state is input is provided immediately after the lamp is turned on. This makes the rising of luminous flux more rapid. Preferably, a power 2.5 to 4 times higher than the lamp power in the stable state is input, and most preferably, a power 3 times higher than that is input. The input lamp power can be adjusted mainly in a lighting circuit.

<Amount of Halides Deposited on the Electrodes When the Lamp is off>

The “amount of halides deposited on the electrodes” when the lamp is off refers to the amount of halides deposited on the peripheries of the electrodes when the lamp is off. The “peripheries of the electrodes” refer to the areas within a 0.2 mm radius of the shaft parts of the electrodes. Thus, the amount of halides deposited on the electrodes refers to the amount of halides deposited in the areas within a 0.2 mm radius of the shaft parts of the electrodes.

In this invention, the amount of halides deposited on the electrodes when the lamp is off is to be reduced. As described later, the degree of reduction of the amount of halides deposited on the electrodes when lamp is off affects the magnitude of the ratio of an instantaneous maximum luminous flux within 2 seconds after the turn-on to a luminous flux in the stable state. That is, if the amount of halides deposited on the electrodes when the lamp is off is adequately reduced, the ratio of the instantaneous maximum luminous flux within 2 seconds after the turn-on to the luminous flux in the stable state is 110% or lower. According to this invention, in the case where the metal halide lamp is used as an automotive headlamp, the amount of halides deposited on the electrodes when the lamp is off is about 0.18 mg or less.

While a measure to reduce the amount of halides deposited on the electrodes when the lamp is off as described above is not limited to a particular one, one or more of measures described below may be used.
1. The parts of the electrodes protruding into the discharge space in the hermetic vessel are reduced. This allows heat of the electrodes to be more readily transferred to root parts thereof, and therefore, the temperature at the root parts increases. Thus, the amount of halides deposited on the electrodes is reduced.
2. Any wedge-shaped or pocket-like clearance is prevented from being formed at the parts of the hermetic vessel where the electrodes are embedded. This inhibits the halides from being deposited at the root parts of the electrodes, and thus, the amount of halides deposited on the electrodes is reduced.
3. The walls of the parts of the hermetic vessel which surround the electrodes provided at opposite ends of the discharge space are brought close to the respective electrodes. This increases the temperature of the root parts of the electrodes, and thus, the amount of halides deposited on the electrodes is reduced.

<Formula (1)>

This invention is to suppress the occurrence of an instantaneous intense light emission within 2 seconds after the lamp is turned on by satisfying the formula (1) having parameters of C(cc), which is the inner volume of the hermetic vessel, T(K), which is the melting point of the halides, H(mg), which is the amount of halides deposited on the electrodes when the lamp is off, and R, which is the ratio of the maximum lamp power at the start of lighting to the lamp power in the stable state. The formula (1) is experimentally derived, and the values of the parameters are absolute ones.

Therefore, as the ratio R of the maximum lamp power at the start of lighting to the lamp power in the stable state, that is, the maximum lamp power at the start of lighting increases, the temperature of the electrodes at the start of lighting increases, and the input power increases. Thus, the amount of light emitted tends to increase, and the instantaneous light emitted within 2 seconds after the turn-on tends to be more intense. In addition, as the melting point T of the halides decreases, the rate of evaporation of the halides increases, the amount of the halides deposited on the electrodes increases, and the instantaneous intense light is more likely to be emitted.

The formula (1) represents a relationship among the above parameters.

<Lamp Power>

The lamp power is a power supplied to the metal halide lamp. According to this invention, it is 50 W or lower in a steady state, that is, a stable state. This means that the lamp is a small metal halide lamp.

<Other Components in this Invention>

The following components are not essential in the metal halide lamp according to this embodiment and other embodiments. However, selectively adding any of these components to the metal halide lamp can enhance the performance and the function thereof.

1. Outer Jacket

The outer jacket houses the discharge vessel therein. The outer jacket can block ultraviolet rays from being emitted from the discharge vessel to the outside, maintain the temperature of the discharge vessel, mechanically protect the discharge vessel or adapt the discharge vessel for any desired purpose. As required, the outer jacket may be hermetically sealed from the outside air or may have air or an inert gas at an atmospheric or reduced pressure sealed therein. Furthermore, as required, it may be communicated with the outside air.

2. Cap

The cap serves to connect the metal halide lamp to the lighting circuit or mechanically support the metal halide lamp at a predetermined position.

3. Igniter

The igniter is to produce a high pulsed voltage and apply the voltage to the metal halide lamp to promote starting of the metal halide lamp. As required, it maybe integrated with the metal halide lamp by being housed inside the cap.

4. Start Assistant Conductor

The start assistant conductor is to increase an electric field strength in the vicinity of the electrodes, thereby facilitating starting of the metal halide lamp. One end of the start assistant conductor is connected to a part at the same potential as one electrode, and the other end thereof is disposed on a region of the outer surface of the discharge vessel in the vicinity of the other electrode.

<Operation of the Invention>

The inventors have observed that, in a mercury-free lamp, there is a mixture of halides deposited on the shaft parts of the electrodes after the lamp is turned off, and the mixture in the liquid phase flows to the tip ends of the electrodes, and also found that the amount of the halides that flow to the tip ends of the electrodes depends on the amount of the halides deposited on the electrodes. It can be considered that this is because the melting point of the mixture of the first metal halide and the second metal halide sealed together is lower than that of the first metal halide, and thus, the time for the mixture of the halides in the liquid phase to be solidified after the lamp is turned off is longer than that for the first halide.

Since the halides have a lower melting point as described above, the halides have an increased evaporation rate. Therefore, at the start of lighting, the halides having moved to the tip ends of the electrodes are evaporated instantaneously and emit instantaneous light. At this time, Na or the like, which is likely to emit light, emits intense light. In addition, at the start of lighting, a high lamp power is continuously input, and therefore, the electrodes have a relatively high temperature, which also promotes the instantaneous light emission at the start of lighting.

In addition, through numerous trials and detailed observations, the inventors have found that the amount of the halides that move to the tip ends of the electrodes depends on the amount of the halides deposited on the electrodes. Specifically, as the amount of the halides deposited on the electrodes increases, the amount of the halides that move to the tip ends of the electrodes also increases, resulting in more intense instantaneous light emission at the start of lighting.

According to the invention, as far as the formula (1) is satisfied, the instantaneous intense light emission for 2 seconds after the turn-on can adequately suppressed. However, if the formula (1) is not satisfied, the instantaneous intense light emission for 2 seconds after the turn-on cannot be suppressed adequately.

In addition, according to the invention, 60% or higher of the luminous flux in the stable state can be readily achieved 4 seconds after the lamp is turned on. Thus, the specification for the automotive headlamp is met. Thus, the instantaneous light emission for 2 seconds after the lamp is turned on is not practically problematic. It is preferred that 60 to 110% of the luminous flux in the stable state is achieved. In such a case, a good rising of luminous flux can be achieved, and the requirement that 60% or higher of the luminous flux in the stable state has to be achieved 4 seconds after the lamp is turned on, which is specified for the metal halide lamp for automotive headlamp use, is readily satisfied, and a smooth change of luminous flux can be achieved during a period from 2 seconds after the lamp is turned on until 4 seconds after the turn-on. Furthermore, if the luminous flux is 105% or lower of that in the stable state, it is not visually perceived as intense light. Here, the rapid rising of luminous flux described above is useful in applications other than the automotive headlamp.

A metal halide lamp according to the embodiment described in claim 2 is characterized in that the metal halide lamp comprises: a discharge vessel having a hermetic vessel which is fire resistant and translucent and has a discharge space therein, and a pair of electrodes sealed at opposite ends of the discharge space in the hermetic vessel with facing each other at a distance of 5 mm or less; and a discharge medium substantially containing no mercury, sealed in the hermetic vessel, and containing a halide of a light-emitting metal and an inert gas, and in a stable state, the metal halide lamp is kept on with a lamp power of 50 W or lower, during a period of 10 seconds after the lamp is turned on, a lamp power 2.2 or more times higher than the lamp power in the stable state is supplied to the lamp, 60% of the luminous flux in the stable state is achieved 4 seconds after the lamp is turned on, and the formula (2) is satisfied:
5<(L_{A-H})³×C_{T}/B_{W}<28 (2),

where the lamp power in the stable state is B_{W} (W), a minimum length between a point in an arc having a maximum luminance and a pool of the discharge medium in the liquid phase is L_{A-H} (mm), and the mass of the discharge space section of the hermetic vessel is C_{T} (mg).

According to this embodiment, a metal halide lamp is prescribed which is turned on and off as an automotive headlamp and arranged to provide a rapid rising of luminous flux. Except for the points described above, the hermetic vessel and electrodes of the discharge vessel and the discharge medium in this embodiment may be the same as those described concerning the embodiment of claim 1.

In the stable state, the metal halide lamp is kept on with a power of 50 W or lower, and during a period of 10 seconds after the lamp is turned on, a lamp power 2.2 or more (preferably 2.5) times higher than the lamp power in the stable state is supplied to the lamp from a lighting circuit. Thus, the metal halide lamp provides 60% or more of the luminous flux in the stable state 4 seconds after the lamp is turned on. Therefore, according to this embodiment, the metal halide lamp is turned on as desired by a metal halide lamp lighting device, which is an implementation of the metal halide lamp that cooperates with the lighting circuit.

The minimum length L_{A-H} (mm) between a point in an arc having a maximum luminance and a pool of the discharge medium in the liquid phase is measured at the middle between the electrodes. The point in an arc having a maximum luminance is determined using a luminance meter. The pool of the discharge medium can be seen by observing laterally the discharge vessel when the lamp is on. The pool of the discharge medium is not significantly changed when the lamp is off. The words “pool of the discharge medium” mainly refers to an excess of halides in the liquid phase adhering to the inner wall of the discharge space.

The mass C_{T} (mg) of the discharge space section of the hermetic vessel refers to the mass of the sheath section of the hermetic vessel that surrounds the discharge space, excluding the mass of the sealing parts connected to the sheath section. The discontinuities between the sheath section and the sealing parts connected thereto can be recognized as boundaries.

The inert gas may be one or more of xenon, krypton, argon and neon. While the pressure of the inert gas is not limited to a particular value, it is preferably 3 atmospheres or higher, more preferably 5 atmospheres or higher and, most preferably, 8 to 16 atmospheres.

The metal halide lamp according to this embodiment is arranged as described above to address the evaporation of the discharge medium, which is inherent to the mercury-free lamp. Therefore, the arc is brought close to the pool of the discharge medium, thereby making the temperature of the discharge medium increase rapidly, and the mass of the hermetic vessel per power is reduced to decrease the thermal capacity thereof. Thus, the rising of luminous flux is significantly improved.

If the metal halide lamp of this embodiment is implemented in combination with the arrangement described in claim 1, the metal halide lamp can be more practical.

The metal halide lamp according to the embodiment described in claim 3 is the metal halide lamp described in claim 2 that is further characterized in that the paired electrodes each have an average diameter of C_{E} (mm) in a section embedded in the hermetic vessel and have a maximum-diameter section in a part protruding into the discharge space, the average diameter of the protruding part being D_{E} (mm), and the formulas (3) and (4) are satisfied:
C_{E}<D_{E} (3), and
D_{E}−C_{E}>0.05 (4).

According to this embodiment, an arrangement is prescribed which has rapid rising of luminous flux due to the improvement of the electrodes and is improved in efficiency and life. Specifically, the electrodes are made of tungsten, doped tungsten, rhenium, a rhenium/tungsten alloy or the like. Since these materials have thermal conductivities remarkably higher than the material of the hermetic vessel, such as quartz glass, if the electrodes are configured as described above, the shaft parts thereof are relatively thin, and the heat transfer from the electrodes to the sealing parts of the hermetic vessel is reduced. As a result, the temperature of the discharge vessel rises more rapidly, more rapid rising of luminous flux is achieved, and the efficiency is improved. In addition, the temperature of the parts of the electrodes embedded in the hermetic vessel is reduced, and therefore, the reaction of the sealed metal foils in the sealing parts with the halides is reduced, so that the life of the metal halide lamp is extended.

Since the parts of the electrodes protruding into the discharge space each have the maximum-diameter section which is wider than that of the metal halide lamp containing mercury, and therefore, the electrodes have a higher thermal capacity, the tip ends of the electrodes are not molten even if a high lamp current flows for a relatively long time at the start of lighting.

If the metal halide lamp of this embodiment is implemented in combination with the arrangement described in claim 1, the metal halide lamp can be more practical.

The maximum-diameter section of the electrode can be formed by mounting a coil of tungsten around the shaft part of the electrode, or formed integrally with the shaft part by trimming a thick tungsten rod.

The metal halide lamp according to the embodiment described in claim 4 is the metal halide lamp described in claim 2 that is further characterized in that the maximum diameter of the part of each of the paired electrodes protruding into the discharge space is B_{E} (mm), the average diameter for the distal 10% thereof is A_{E} (mm), and the formula (5) is satisfied:
A_{E}<B_{E} (5).

According to this embodiment, an arrangement is prescribed which has improved electrodes and thus is improved in stability of discharge. If the electrodes are configured as described above, the electrodes have the maximum diameter at a short distance from the tip ends thereof. Therefore, the shaft parts of the electrodes are relatively thin, and the temperature thereof is increased, so that the thermionic emission at the tip ends is improved, and the discharge is stabilized. Thus, extinction of the arc or occurrence of a luminance flicker can be prevented. In addition, since the maximum-diameter sections are formed at a short distance from the tip ends of the electrodes, the electrodes have a higher thermal capacity, the tip ends of the electrodes are not molten even if a high lamp current flows for a relatively long time at the start of lighting.

The maximum-diameter section of the electrode can be formed by mounting a coil of tungsten around the shaft part, or formed integrally with the shaft part by trimming a thick tungsten rod.

The inert gas may be one or more of xenon, krypton, argon and neon. However, xenon is preferably used. While the pressure of the inert gas is not limited to a particular value, it is preferably 3 atmospheres or higher, more preferably 5 atmospheres or higher and, most preferably, 8 to 16 atmospheres.

If the metal halide lamp of this embodiment is implemented in combination with the arrangement described in claim 1, the metal halide lamp can be more practical.

The metal halide lamp according to the embodiment described in claim 5 is the metal halide lamp described in claim 2 that is further characterized in that the paired electrodes each have an average diameter of C_{E} (mm) in a section embedded in the hermetic vessel, the maximum diameter of the part of each of the paired electrodes protruding into the discharge space is B_{E} (mm), the average diameter for the distal 10% thereof is A_{E} (mm), the average diameter of the protruding part being D_{E} (mm), and the formulas (3) and (6) are satisfied:
C_{E}<D_{E} (3), and
A_{E}<D_{E}<B_{E} (6).

According to this embodiment, an arrangement is prescribed in which displacement of a cathode spot is suppressed to prevent the light distribution characteristic from fluctuating, and the tip ends of the electrodes are made less susceptible to damage. Arranged as described above, a cathode spot is formed. However, since the electrodes have the thin tip ends, the location where the cathode spot is formed is less variable, so that the light distribution characteristic is less susceptible to fluctuation.

In addition, since xenon gas is sealed at 8 to 16 atmospheres, the pressure of 16 atmospheres being preferred to avoid the risk of bursting, a high lamp voltage can be achieved during the discharge contributed only by xenon immediately after turn-on. Therefore, a reduced maximum lamp current is enough to input a desired lamp power to the lamp during this period, so that the electrodes can be thinner. Consequently, displacement of the cathode spot and, therefore, fluctuation of the light distribution are further suppressed.

Furthermore, since the electrodes have the maximum diameter sections at a short distance from the tip ends thereof, the electrodes have a higher thermal capacity, so that the heat dissipation is accelerated and the temperature reduction is improved.

The metal halide lamp according to the embodiment described in claim 6 is the metal halide lamp described in claim 2 that is further characterized in that each of the paired electrodes has a large-diameter section at a short distance from the tip end, and an angle Q_{E} (°) between the axis of the electrode and a line drawn from a shoulder of the tip end to pass through an outermost point of the large-diameter section satisfies the formula (7):
24≦Q_{E}≦43 (7).

Having the arrangement described above, this embodiment provides substantially the same operation and advantage as those described in claim 5.

In addition, the arc tends to be curved when heavy xenon is sealed at 8 atmospheres or higher. However, according to this embodiment, even if the arc is curved significantly, the outermost point of the large-diameter section formed at a short distance from the tip end of the electrode lies within a range of the angle Q_{E}, so that the cathode spot is prevented from being formed unwantedly at the maximum-diameter section. Here, the “outermost point” refers to a point in the circumference of the large-diameter section with which the line drawn from a shoulder of the tip end of the electrode first intersects.

When checking whether the outermost point of the large-diameter section of the electrode satisfies the abode-described condition, if the tip end of the electrode is semi-spherical or paraboloidal, the tip end is assumed to be planar to determine the shoulder.

A metal halide lamp according to the embodiment described in claim 7 is characterized in that the metal halide lamp comprises: a discharge vessel having a hermetic vessel which is made of quartz glass and has a discharge space therein, and a pair of electrodes provided at opposite ends of the discharge space in the hermetic vessel with facing each other at a distance of 5 mm or less, the atom density ratio A (%) of SiO₂ at the surface of the tip ends of the electrodes satisfying the formula (8):
2.5<A<43 (8),

a discharge medium substantially containing no mercury, sealed in the hermetic vessel, and containing xenon gas at 3 atmospheres or higher and at least one of halides of sodium Na, scandium Sc and a rare earth metal, in a stable state, the metal halide lamp is kept on with a lamp power of 50 W or lower, and a period in which a power two or more times higher than the lamp power in the stable state is input is provided immediately after the lamp is turned on.

According to this embodiment, an arrangement is prescribed which substantially uses no mercury out of consideration to the environment, provides for rapid rising of luminous flux, and is improved in reliability by reducing wear of the electrodes to suppress the occurrence of various defects due to the wear of the electrodes. Except for the points described above, the hermetic vessel and electrodes of the discharge vessel and the discharge medium in this embodiment may be selectively configured the same as those described in claim 1 and/or claims 2 to 6.

The pair of electrodes are sealed in the hermetic vessel with facing each other at the opposite ends of the discharge space and spaced apart from each other by 5 mm or less, and the atom density ratio A (%) of SiO₂ at the surface of the tip ends of the electrodes satisfies the formula (8). Here, the atom density ratio A(%) of SiO₂ at the surface of the tip ends of the electrodes to a depth of several nanometers is measured with an XPS (X-ray diffractometer).

By the atom density ratio A(%) of SiO₂ satisfying the formula (8), the intended object that wear of the electrodes is reduced to suppress the occurrence of various defects due to the wear of the electrodes, thereby improve the reliability of the metal halide lamp is attained.

However, if the atom density ratio A(%) is higher than 43%, the wear of the electrodes becomes significant, whitening, blackening and/or increase of the distance between the electrodes are beyond the respective acceptable levels, and the luminous flux maintenance factor is reduced accordingly. Therefore, such an atom density ratio is not acceptable. The whitening is caused by the scattered electrode material reacting with quartz glass forming the translucent hermetic vessel. The blackening is caused by the scattered electrode material adhering to the wall of the translucent hermetic vessel. On the other hand, in the case of the mercury-containing lamp, an atom density ratio A(%) of SiO₂ of about 68% or lower is acceptable.

On the other hand, when the atom density ratio A(%) is lower than 2.5%, the operation and advantage of the metal halide lamp are not remarkably different from those of the metal halide lamp with the atom density ratio falling within the range prescribed in this embodiment. However, if the atom density ratio A(%) of SiO₂ is reduced to such a low value, the manufacture cost of the metal halide lamp increases significantly and the manufacture thereof becomes extremely difficult. Therefore, such an atom density ratio is not acceptable. Preferably, the atom density ratio falls within the range expressed by the formula (9). That is, as far as it falls within the range, even if, instead of mercury, a halide of a metal, such as Zn, which increases the lamp voltage is sealed as a second halide together with the halide of a light-emitting metal, the life of the metal halide lamp is not significantly reduced.
2.5<A<20 (9)

In order to control the atom density ratio A(%) of SiO₂ at the surface of the tip ends of the electrodes as desired as described above, one or more of exemplary measures described below may be advantageously, selectively used. However, this invention is not limited to use of a particular measure.
1. The electrodes are sealed in the translucent hermetic vessel, and the time required to process, that is, hermetically close the open ends of the translucent hermetic vessel is shortened.
2. The bulb section of the translucent hermetic vessel is shielded from heat to prevent a high temperature of the bulb section during the processing described above.
3. The hermetic vessel is sealed containing a heavy gas at a high pressure.
4. The processing described above is conducted with the gas flowing.

The metal halide lamp according to the embodiment described in claim 8 is the metal halide lamp described in claim 7 that is further characterized in that the paired electrodes each have a part protruding into the discharge space which has a length of 1.9 mm or less.

According to this embodiment, an arrangement is prescribed to which a required lamp characteristic is easily imparted and in which wear of the electrodes is suppressed. In order to control the atom density ratio A(%) of SiO₂ at the surface of the tip ends of the electrodes as desired as prescribed in claim 7, the parts protruding into the discharge space can be elongated to locate the tip ends of the electrodes away from the sealing parts. However, if such a measure is taken, there arises a problem that it is difficult to provide a required lamp characteristic.

According to this embodiment, as far as the length of the protruding parts of the electrodes is 1.9 mm or less as described above, a required lamp characteristic can be secured. However, when the length of the protruding parts of the electrodes is 1.9 mm or less, the atom density ratio A(%) of SiO₂ at the surface of the tip ends of the electrodes is higher than the upper limit of the formula (8) with a probability of 40%. However, the measures in the above description concerning the embodiment described in claim 7 can be used to satisfy the formula (8), for example. As a result, wear of the electrodes can be effectively suppressed.

According to this embodiment, in order to provide a desired lamp characteristic, the lamp voltage can be set to fall within a range of 25 to 70 V.

The metal halide lamp according to the embodiment described in claim 9 is the metal halide lamp described in any one of claims 1 to 8 that is further characterized in that the discharge medium contains a halide of a light-emitting metal as a first halide, and one or more of halides of Mg, Co, Cr, Zn, Mn, Sb, Re, Ga, Sn, Fe, Al, Ti, Zr and Hf as a second halide.

According to this embodiment, an arrangement is prescribed in which the second halide, which serves to provide a lamp voltage instead of mercury, is added to the first halide, which is a halide of a light-emitting metal. The second metal halide is characterized in that it has a relatively high vapor pressure and emits relatively little visible light. Thus, selectively sealing an appropriate amount of second halide can increase the lamp voltage so as to fall within a desired range. Therefore, a required lamp power can be input with a relatively low lamp current.

The metal halide lamp according to the embodiment described in claim 10 is the metal halide lamp described in claim 9 that is further characterized in that the second halide is a halide of Zn.

According to this embodiment, an arrangement is prescribed in which a preferred second halide is used. That is, Zn has a high vapor pressure, emits blue light and, therefore, is capable of color adjustment. Zn is available at a low cost in a required amount and is highly safety.

A metal halide lamp lighting device according to the embodiment described in claim 11 is characterized in that the metal halide lamp lighting device comprises: a metal halide lamp according to any one of claims 1 to 10; and a lighting circuit in which a maximum lamp power at the start of lighting within 4 seconds after the metal halide lamp is turned on is two to four times higher than a lamp power in a stable state.

This embodiment relates to a metal halide lamp suitable for an automotive headlamp.

According to this embodiment, since the lighting device is controlled to make the maximum lamp power within 4 seconds after the metal halide lamp is turned on 2 to 4 times higher than the lamp power in the stable state, the rising of luminous flux within 4 seconds after the lamp is turned on can be more rapid. In this invention, alternating-current lighting or direct-current lighting may be adopted. In the case of the alternating-current lighting, a low-frequency rectangular alternating-current voltage can be applied to turn on the metal halide lamp to effectively suppress the occurrence of an acoustic resonance.

Furthermore, the lighting circuit can be designed to have a no-load output voltage of 200 V or lower. The lamp voltage of the metal halide lamp used in this invention is lower than that of the mercury-containing lamp, and therefore, the no-load output voltage of the lighting circuit can be 200 V or lower. This enables downsizing of the lighting circuit. Here, in the case of the mercury-containing lamp, a no-load output voltage of about 400 V is required.

An automotive headlamp apparatus according to the embodiment described in claim 12 is characterized in that the automotive headlamp apparatus comprises: an automotive headlamp apparatus main unit; a metal halide lamp according to any one of claims 1 to 10 which is installed in the automotive headlamp apparatus main unit with the axis of a discharge vessel thereof being aligned with an optical axis of the automotive headlamp apparatus main unit; and a lighting circuit in which a maximum lamp power at the start of lighting within 4 seconds after the metal halide lamp is turned on is two to four times higher than a lamp power in a stable state.

Since the automotive headlamp apparatus of this embodiment has the metal halide lamp described in any of claims 1 to 10 as a light source, it provides a rapid rising of luminous flux and is safety. In addition, since the metal halide lamp contains no mercury, which applies a significant load to the environment, the automotive headlamp apparatus is highly preferable from an environmental viewpoint. Here, the “automotive headlamp apparatus main unit” refers to the whole of the automotive headlamp apparatus excluding the metal halide lamp and the lighting circuit.

### BRIEF DESCRIPTION OF THE DRAWINGS

FIG. 1 is a graph showing variations of lamp currents of a mercury-free lamp and a mercury-containing lamp after the lamps are turned on;

FIG. 2 is a graph showing variations of electrode temperatures thereof;

FIG. 3 is a graph showing variations of vapor pressures thereof;

FIG. 4 is a graph showing rising characteristics of luminous flux of a conventional mercury-free lamp and a mercury-free lamp according to the present invention at the time of turn-on;

FIG. 5 is a front view of a metal halide lamp according to an embodiment described in claim 1;

FIG. 6 is an enlarged view of an essential part of the metal halide lamp turned off;

FIG. 7 is a graph showing how the starting light emission ratio maximum value varies when the ratio H/C of the amount H of the halides deposited on the electrodes to the inner volume C of the hermetic vessel and the value of the formula (1) are varied;

FIG. 8 is a graph showing how the starting light emission ratio maximum value varies when the melting point T of the halides and the value of the formula (1) are varied;

FIG. 9 is a graph showing how the starting light emission ratio maximum value varies when the ratio R of the maximum lamp power at the start of lighting to the lamp power in a stable state and the value of the formula (1) are varied;

FIG. 10 is a front view of essential parts of a metal halide lamp according to an embodiment described in claim 2;

FIG. 11 is a cross sectional view of the middle part of the metal halide lamp;

FIG. 12 is a graph showing relationships between the rising of luminous flux 4 seconds after lamp's turning on and the value of (L_{A-H})³×C_{T}/B_{W} and between the relative lamp life and the value of (L_{A-H})³×C_{T}/B_{W} in the case where a lamp power 2.4 times higher than the lamp power in the stable state is input;

FIG. 13 is an enlarged front view of essential parts of a metal halide lamp according to embodiments described in claims 3 to 5;

FIG. 14 is an enlarged front view of essential parts of a metal halide lamp according to an embodiment described in claim 6;

FIG. 15 is a graph showing how the electrode life and the distance to an arc-originating point vary when an electrode tip angle Q is varied in the example shown in FIG. 14;

FIG. 16 is an enlarged front view of essential parts of a metal halide lamp according to a modification of the embodiment described in claim 6;

FIG. 17 is an enlarged front view of essential parts of a metal halide lamp according to another modification of the embodiment described in claim 6;

FIG. 18 is a graph showing how a 2000-hour luminous flux maintenance factor varies when an atom density ratio A of SiO₂ at the surface of the tip end of the electrode varies in the embodiment described in claim 7;

FIG. 19 is a graph showing a relationship between the length of the protruding part of the electrode and the atom density ratio A of SiO₂ at the surface of the tip end of the electrode in the case where one end of the hermetic vessel made of quartz glass is sealed while sealing therein the electrodes without using any particular means to reduce the atom density ratio of SiO₂;

FIG. 20 is a front view illustrating another example according to the embodiments described in claims 1, 2 and 7;

FIG. 21 is a circuit diagram of a metal halide lamp lighting device according to an embodiment described in claim 11;

FIG. 22 is a perspective view of an automotive headlamp apparatus according to an embodiment described in claim 12; and

FIG. 23 is an enlarged front view of essential parts of a conventional mercury-containing lamp turned off.

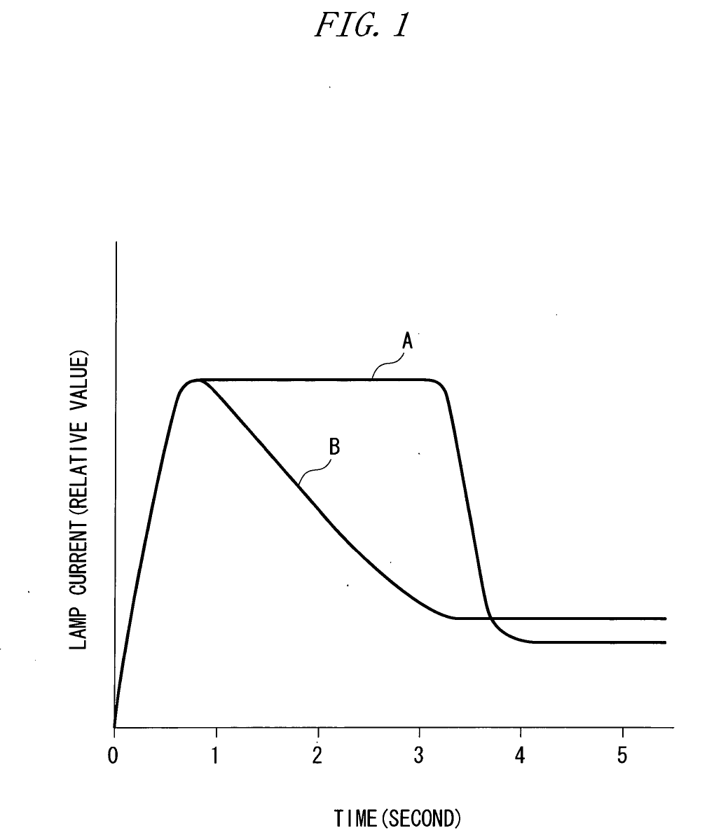

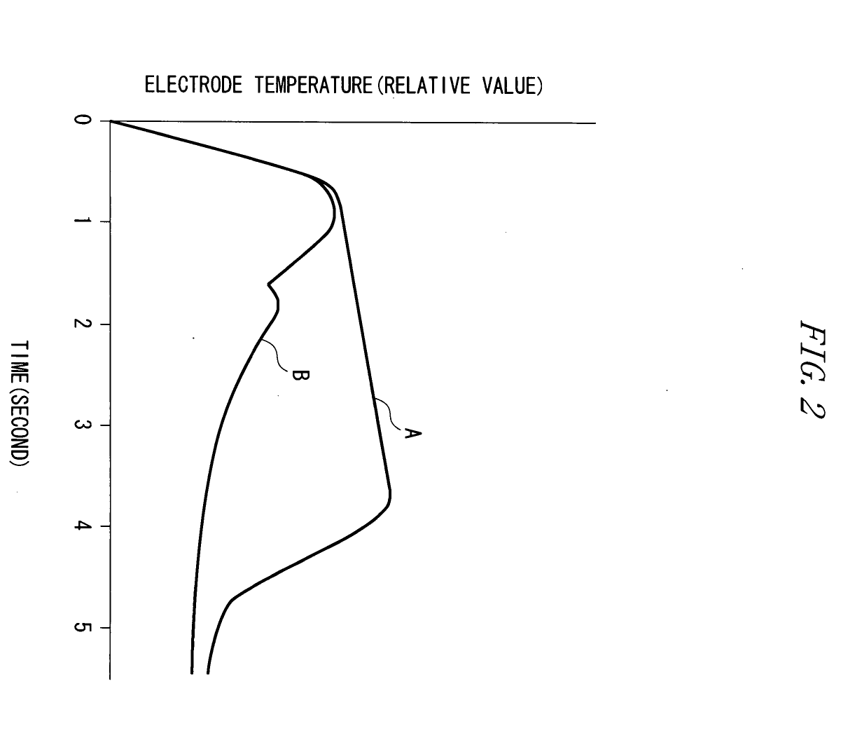

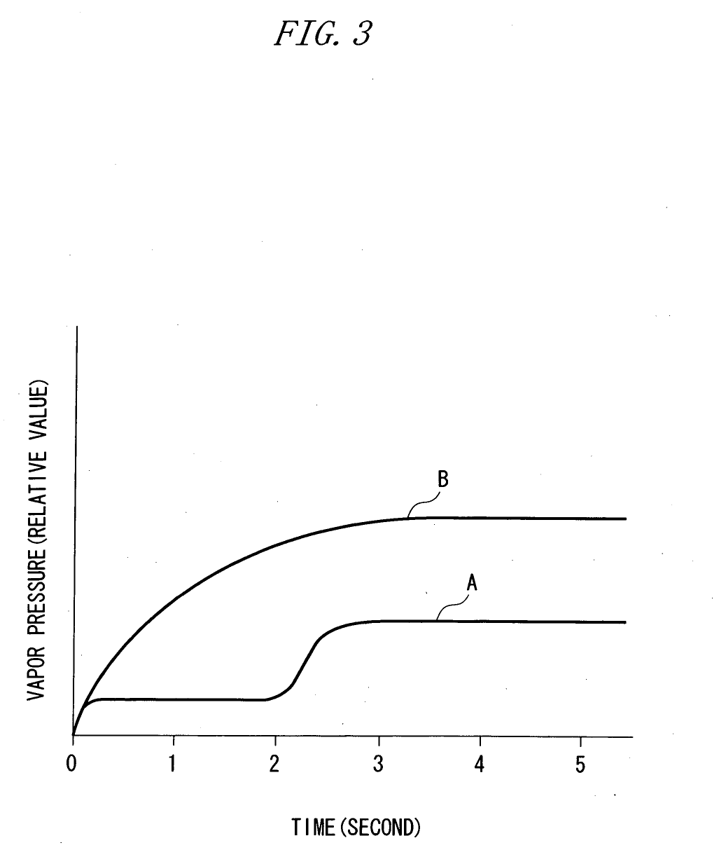

### BEST MODE FOR CARRYING OUT THE INVENTION

In the following, embodiments described in the claims will be described with reference to the drawings.

<Embodiment Described in Claim 1>

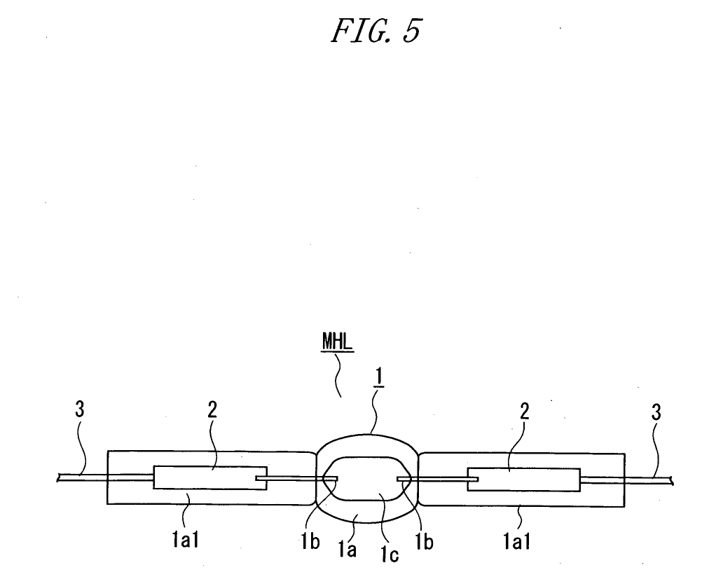

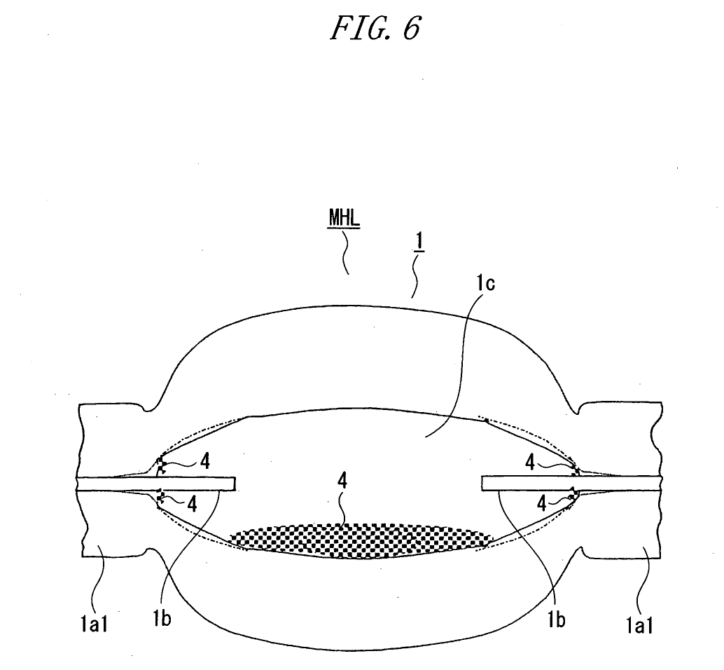

This embodiment will be described with reference to FIGS. 5 and 6. In the drawings, a metal halide lamp MHL comprises a discharge vessel 1, a sealed metal foil 2, an externally introduced line 3 and a discharge medium.

The discharge vessel 1 comprises a translucent hermetic vessel 1a and a pair of electrodes 1b, 1b. The hermetic vessel 1a is shaped into a hollow spindle and has a pair of elongated sealing parts 1a1 formed integrally therewith at both ends. The inside of the hermetic vessel 1a provides an elongated and substantially cylindrical discharge space 1c. The volume of the discharge space 1c of the hermetic vessel 1a, that is, the inner volume thereof is denoted by C in terms of cc.

The paired electrodes 1b, 1b are held at predetermined positions with their base ends embedded in the sealing parts 1a1 and their tip ends protruding into the discharge space 1c. The base portion of each electrode 1b is welded to one end of the sealed metal foil 2 in the sealing part 1a1.

The sealed metal foil 2 is made of molybdenum and hermetically sealed in sealing part 1a1 of the hermetic vessel 1a.

The externally introduced line 3 has a tip end welded to the sealed metal foil 2 in the sealing part 1a1.

The discharge medium is composed of halides and xenon and sealed in the discharge space 1c of the hermetic vessel 1a. When the metal halide lamp is on, an excess of the halide is in the liquid phase and deposited on the inner wall of the hermetic vessel 1a. Reference numeral 4 in FIG. 6 denotes the halides in the liquid phase. The halides sealed in the hermetic vessel 1a are a first metal halide, which is a halide of a light-emitting metal, and a second halide, which has a relatively high vapor pressure. The melting point of the mixture of the halides is denoted by T in terms of K. The first halide contains a halide of sodium Na and at least one of halides of scandium Sc and rare earth metals. A significant amount of the sealed halides is deposited on the inner surface of the hermetic vessel 1a in the form of the halide 4 in a liquid state, and the amount of the halides deposited on the electrodes 1b is reduced. This is because the shape of the end parts of the hermetic vessel 1a surrounding the electrodes 1b is modified from the one indicated by the dashed line to the one indicated by the solid line, thereby bringing the inner wall close to the electrodes, the shape of the parts of the hermetic vessel 1a in which the electrode are embedded is modified from the one indicated by the dotted line to the one indicated by the solid line, thereby eliminating the wedge-shaped clearance, and, although not shown, the length of the discharge space is reduced. Xenon is sealed in the vessel at 3 atmospheres or higher.

The metal halide lamp according to this embodiment is turned on at a ratio R of a starting maximum lamp power to a stable lamp power. In the following, examples and a comparison example will be described. The comparison example is related with a conventional mercury-free lamp. The “starting light emission ratio maximum value” refers to a ratio of an instantaneous maximum luminous flux within 2 seconds after the lamp is turned on to a luminous flux in a stable state.

### (EXAMPLE 1)

Discharge Vessel

The hermetic vessel 1a was made of quartz glass and had an outer diameter of 6 mm, an inner diameter of 3 mm, an inner volume of 0.03 cc, and a discharge space length of 6.6 mm.

The electrodes 1b were made of tungsten, the shaft parts thereof had a diameter of 0.4 mm, and the distance between the electrodes was 4.2 mm.

Discharge Medium

The halides used were ScI₃, NaI and ZnI₂ in a relation of ScI₃−NaI−ZnI₂=1.2 mg, the amount H of the halides deposited on the electrodes was 0.03 mg, and the melting point T thereof was 650 K.

Xenon Gas was at 10 Atmospheres.

The maximum lamp power at the start of lighting was 105 W, and the lamp power in a stable state was 35 W.

The value X of the formula (1), that is, (H/C)×[R/(T/500)⁶] was 0.62.

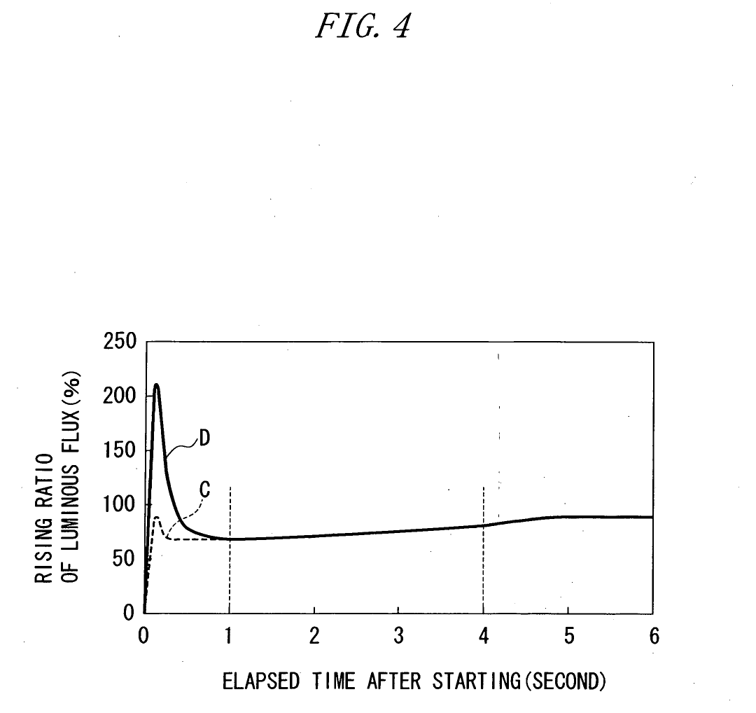

The starting light emission ratio maximum value E was 105% (indicated by the curve C in FIG. 4), and no visible orange light was emitted.

### (EXAMPLE 2)

Discharge Medium

The amount H of the halides deposited on the electrodes was 0.15 mg, and the melting point T thereof was 750 K.

The other points were the same as those in Example 1.

The value X of the formula 1 was 1.31.

The starting light emission ratio maximum value E was 105%, and no visible orange light was emitted.

### (Example 3)

Discharge Medium

The amount H of the halides deposited on the electrodes was 0.15 mg, and the melting point T thereof was 650 K.

The other points were the same as those in Example 1.

The maximum lamp power at the start of lighting was 70 W.

The other points were the same as those in Example 1.

The value X of the formula 1 was 2.07.

The starting light emission ratio maximum value E was 60%, and no visible orange light was emitted.

### (COMPARISON EXAMPLE)

Discharge Vessel

The hermetic vessel 1a was made of quartz glass and had an outer diameter of 6 mm, an inner diameter of 3 mm, an inner volume C of 0.03 cc, and a discharge space length of 7.8 mm.

The electrodes 1b were made of tungsten, the shaft parts thereof had a diameter of 0.4 mm, and the distance between the electrodes was 4.2 mm.

Discharge Medium

The halides used were ScI₃, NaI and ZnI₂ in a relation of ScI₃−NaI−ZnI₂=1.2 mg, the amount H of the halides deposited on the electrodes was 0.22 mg, and the melting point T thereof was 650 K.

Xenon gas was at 10 atmospheres.

The maximum lamp power at the start of lighting was 105 W, the lamp power in a stable state was 35 W, and the ratio R of the maximum lamp power at the start of lighting to the lamp power in a stable state was 3.

The value X of the formula (1) was 4.56.

The starting light emission ratio maximum value E was 160% (indicated by the curve C in FIG. 4), and orange light was emitted.

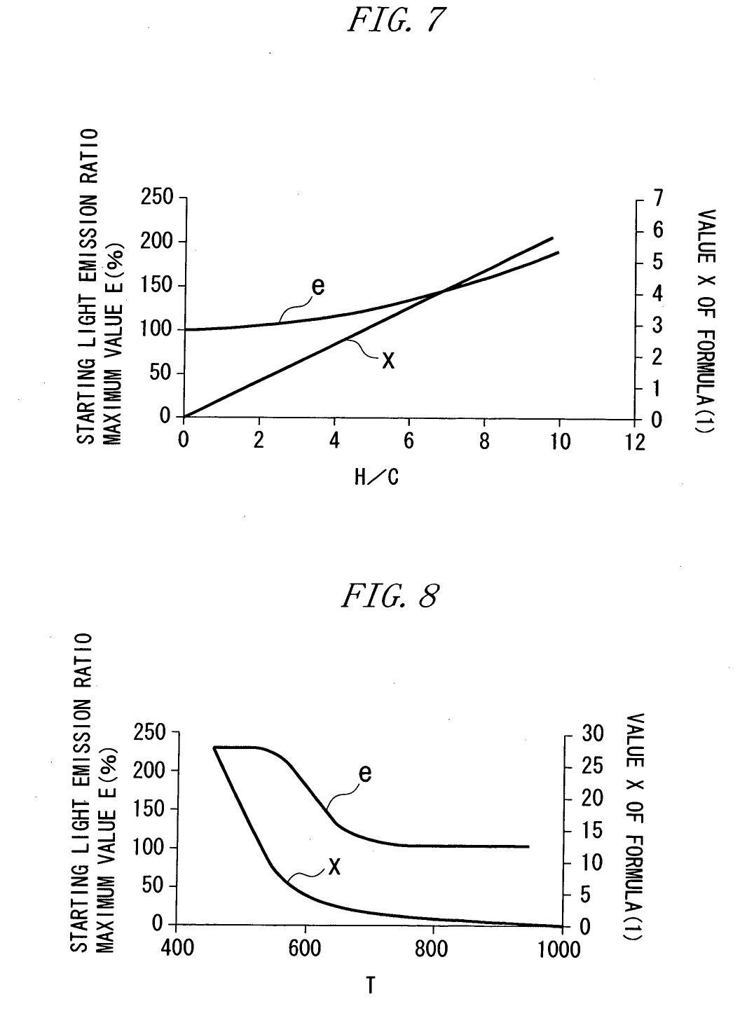

Now, with reference to FIGS. 7 to 9, there will be described how the starting light emission ratio maximum value E varies when the amount H of the halides deposited on the electrodes, the inner volume C of the hermetic vessel, the melting point T of the halides and the ratio R of the maximum lamp power at the start of lighting to the lamp power in a stable state are varied. In these drawings, the left-side vertical axis indicates the starting light emission ratio maximum value E, and the right-side vertical axis indicates value of the formula (1). In these drawings, the curve e is for the starting light emission ratio maximum value E, and the curve x is for the value X of the formula (1).

FIG. 7 shows how the starting light emission ratio maximum value and the value of the formula (1) vary when the ratio H/C of the amount H of the halides deposited on the electrodes to the inner volume C of the hermetic vessel is varied. In this drawing, the horizontal axis indicates the ratio H/C of the amount H of the halides deposited on the electrodes to the inner volume C of the hermetic vessel.

FIG. 8 shows how the starting light emission ratio maximum value and the value of the formula (1) vary when the melting point T of the halides is varied. In this drawing, the horizontal axis indicates the melting point T of the halides.

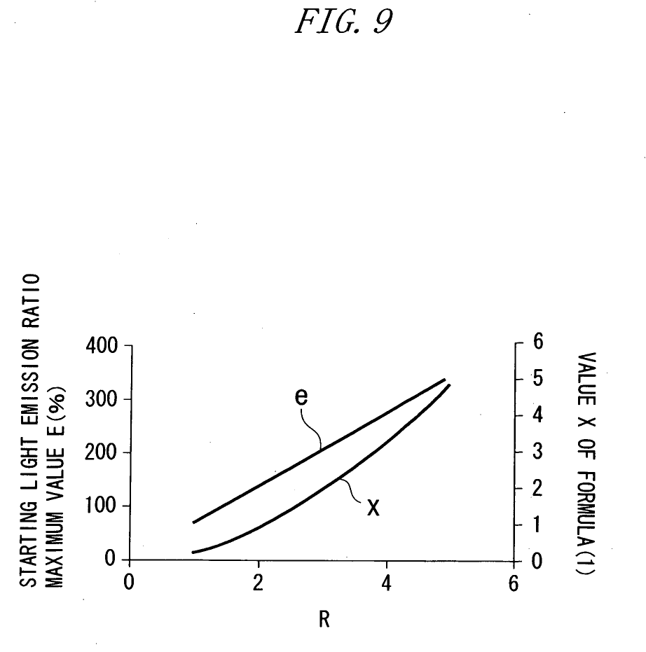

FIG. 9 shows how the starting light emission ratio maximum value and the value of the formula (1) vary when the ratio R of the maximum lamp power at the start of lighting to the lamp power in a stable state is varied. In this drawing, the horizontal axis indicates the ratio R of the maximum lamp power at the start of lighting to the lamp power in a stable state.

As can be seen from these drawings, the values of the formula (1) relatively approximate to experimental values, and thus, the formula (1) is appropriate.

<Embodiment Described in Claim 2>

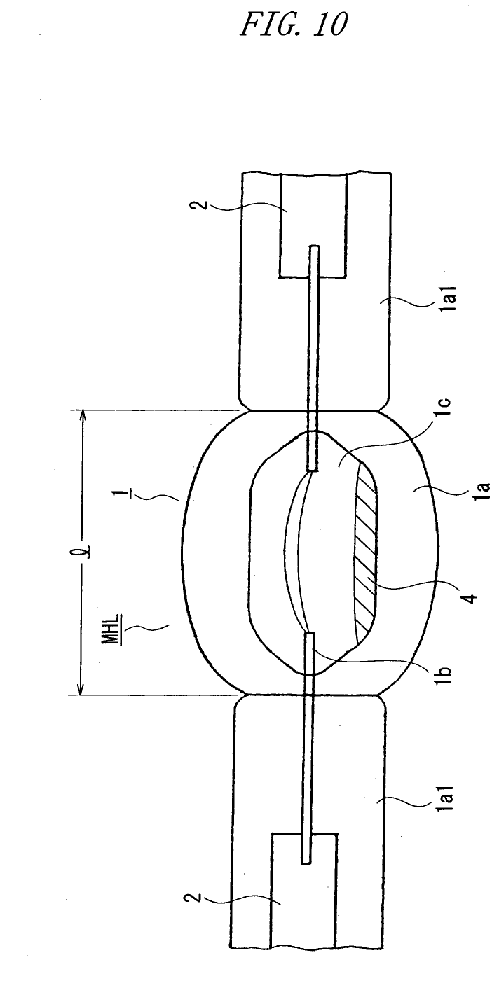

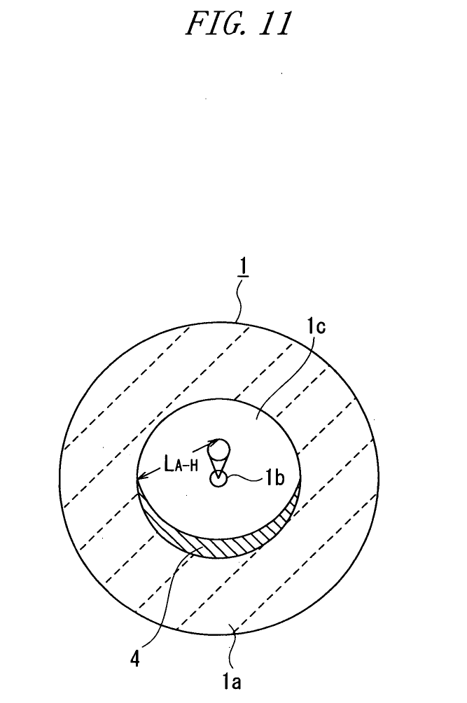

This embodiment will be described with reference to FIGS. 10 and 11. While the metal halide lamp according to this embodiment is apparently similar to that shown in FIG. 5, the lamp power B_{W} (W) in a stable state, the thickness d_{A} (mm) of an arc, the minimum length L_{A-H} (mm) between a point in the arc having a maximum luminance and a pool of the discharge medium and the mass C_{T} (mg) of the discharge space section (having a length of 1) of the hermetic vessel are determined to satisfy the formula (2) (5<(L_{A-H})³×C_{T}/B_{W}<28).

### (EXAMPLE 4)

Discharge Vessel

The hermetic vessel 1a was made of quartz glass and had an outer diameter of 5 mm, an inner diameter of 2.2 mm, and a length of 6.5 mm, and the mass C_{T} of the discharge space section was 250 mg.

The electrodes 1b were made of tungsten, the diameter of the tip ends thereof was 0.4 mm, the length of the protruding sections thereof was 2.3 mm, the diameter d_{E} of the shafts parts was 0.4 mm, and the distance between the electrodes was 4.2 mm.

Discharge Medium

The halides used were ScI₃, NaI and ZnI₂ in a relation of ScI₃−NaI−ZnI₂=0.2 mg.

Xenon gas was at 6 atmospheres.

The lamp power B_{W} in a stable state was 35 W, and the minimum length L_{A-H} was 1.4 mm.
(L_{A-H})³×C_{T}/B_{W}=19.60

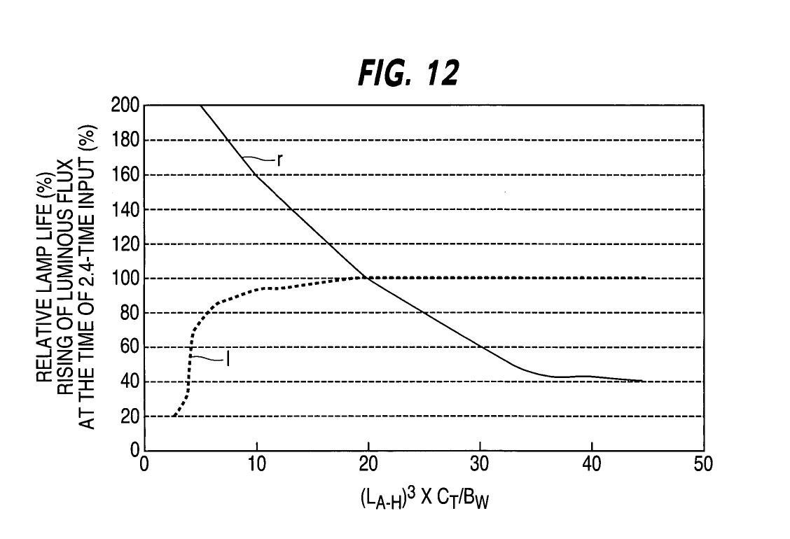

Now, concerning Example 4, the rising of luminous flux 4 seconds after the lamp is turned on and the life of the electrodes in the case where the variable term ((L_{A-H})³×C_{T}/B_{W}) of the formula (2) is changed will be described with reference to FIG. 12. In FIG. 12, the horizontal axis indicates the value of (L_{A-H})³×C_{T}/B_{W}, and the vertical axis indicates the rising of luminous flux (%) at the time of 2.4-time input and the relative lamp life (%). The curve r is for the rising of luminous flux, and the curve 1 is for the electrode life. Here, the “rising of luminous flux at the time of 2.4-time input” described above means the rising of luminous flux 4 seconds after the lamp is turned on in the case where a lamp power 2.4 times higher than the lamp power in the stable state is input. In addition, the “relative lamp life” is a relative value of lamp life assuming that the longest lamp life data is 100%.

As can be seen from this drawing, if the value of the formula (2) is lower than the lower limit thereof, the value of the rising of luminous flux becomes extremely high, and the electrode life is extremely deteriorated. And, if the value of the formula (2) is higher than the upper limit thereof, the value of the rising of luminous flux is lower than 70%.

<Embodiments Described in Claims 3 to 5>

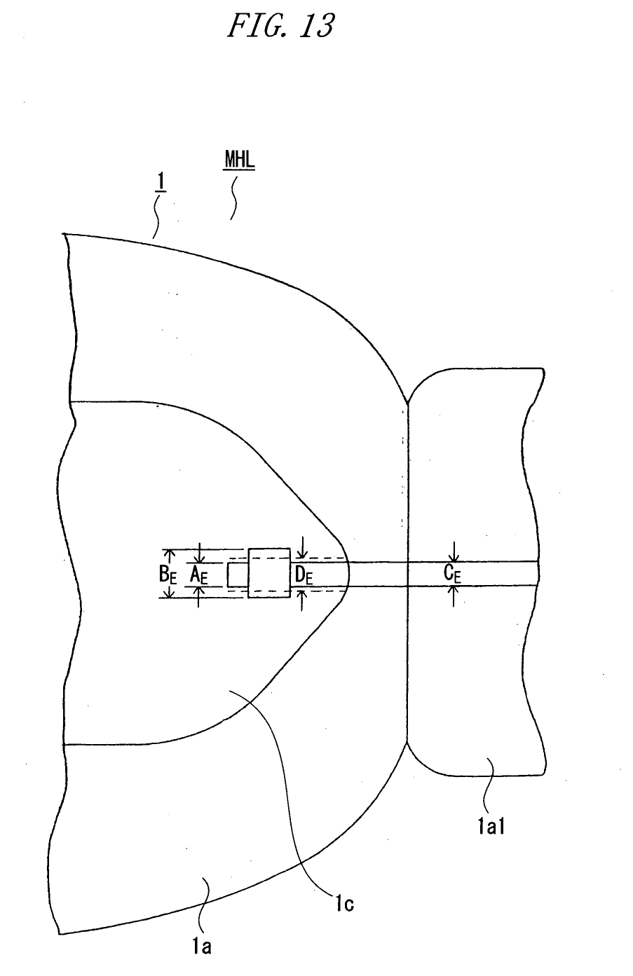

These embodiments will be described with reference to FIG. 13. According to these embodiments, the electrode 1b has a maximum-diameter section 1b2 composed of a tungsten coil at a short distance from the tip end 1b1 of the electrodes 1b. The tip end 1b1 has a diameter of A_{E} (mm), the maximum-diameter section 1b2 has a diameter of B_{E} (mm), the part protruding into the discharge space 1c has an average diameter of D_{E} (mm), and the part 1b4 embedded in the sealing part has an average diameter of C_{E} (mm).

The embodiment according to claim 3 satisfies the formulas (6) and (7), the embodiment according to claim 4 satisfies the formula (8), and the embodiment according to claim 5 satisfies the formulas (9) and (10).

### (EXAMPLE 5)

Discharge Vessel

The hermetic vessel 1a was made of quartz glass and had an outer diameter of 6 mm and an inner diameter of 3.0 mm.

The electrodes 1b were made of tungsten. The diameter A_{E} of the tip end 1b1 thereof (10% from the tip) was 0.3 mm, the diameter B_{E} of the maximum-diameter section 1b2 was 0.5 mm, the average diameter d_{E} of the protruding part was 0.42 mm, the average diameter C_{E} of the embedded part 1b4 was 0.3 mm and the distance between the electrodes was 4.2 mm.

Discharge Medium

The halides used were ScI₃, NaI and ZnI₂ in a relation of ScI₃−NaI−ZnI₂=0.2 mg.

Xenon gas was at 6 atmospheres.

The lamp power in a stable state was 35 W.

<Embodiment Described in Claim 6>

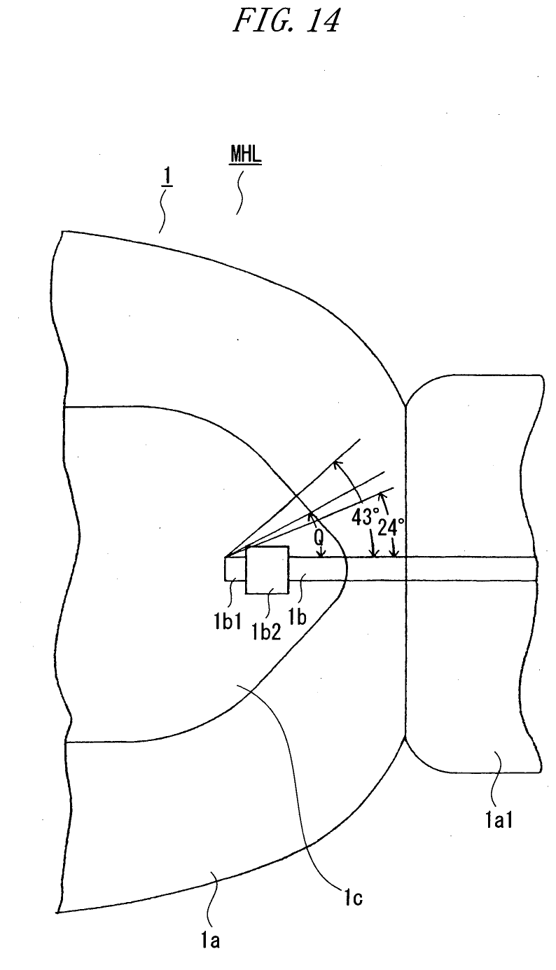

This embodiment will be described with reference to FIG. 14. According to this embodiment, the electrode 1b has a maximum-diameter section 1b2 composed of a tungsten coil at a short distance from the tip end 1b1, and an electrode tip angle Q between a line parallel to the axis of the hermetic vessel 1a and a line connecting the tip end of the electrode to a shoulder of the maximum-diameter section 1b2 near the tip end falls within a range of 24 to 43 degrees.

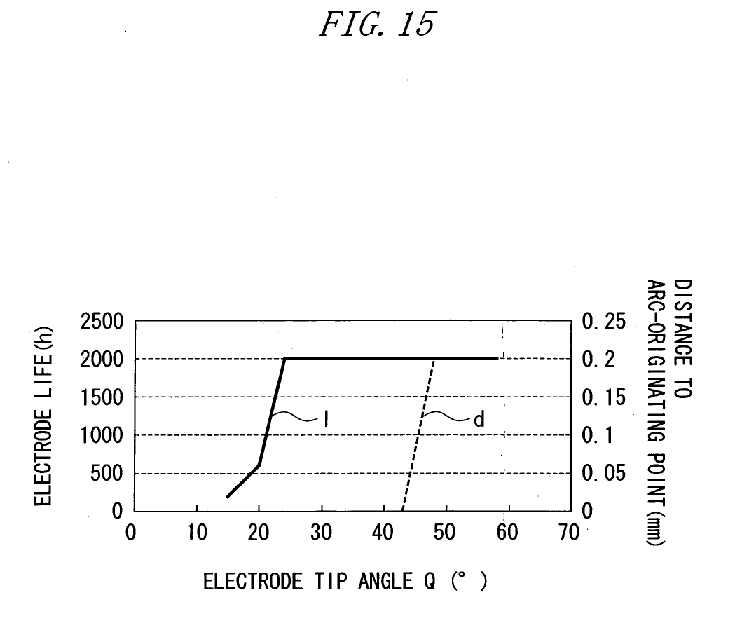

Now, with reference to FIG. 15, there will be described how the life of the electrode and the distance to an arc-originating point vary when the electrode tip angle Q is varied. In this drawing, the horizontal axis indicates the electrode tip angle Q (°), and the left-side vertical axis indicates the life (h) of the electrode, and the right-side vertical axis indicates the distance (mm) to the arc-originating point. The “distance to an arc-originating point” refers to the distance from the tip of the electrode to the point where an arc is originated. The curve 1 is for the life of the electrode, and the curve d is for the distance to the arc-originating point.

As can be seen from this drawing, when the electrode tip angle Q falls within the range of 24 to 43 degrees, the distance to the arc-originating point is 0, and the life of the electrode is long.

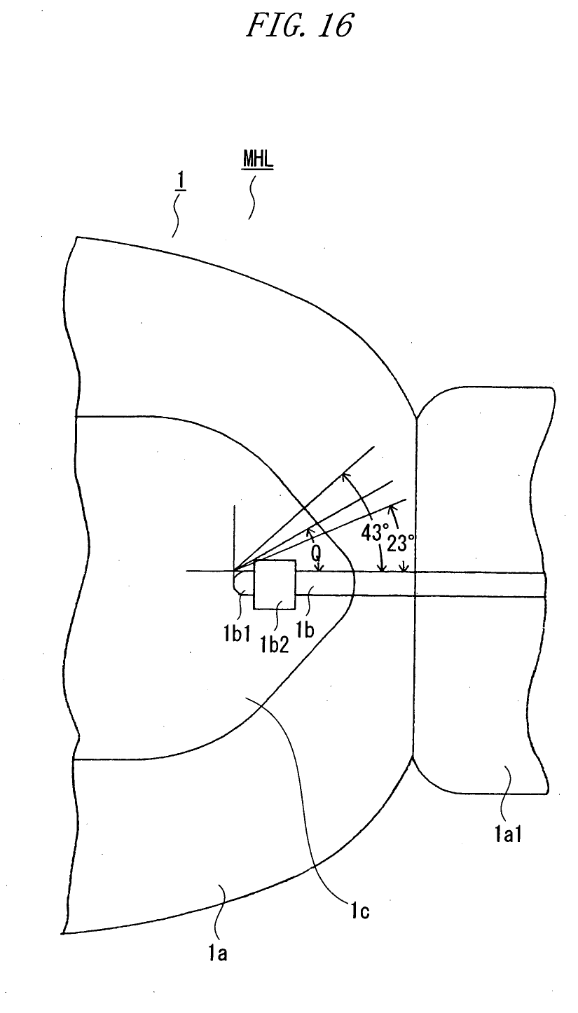

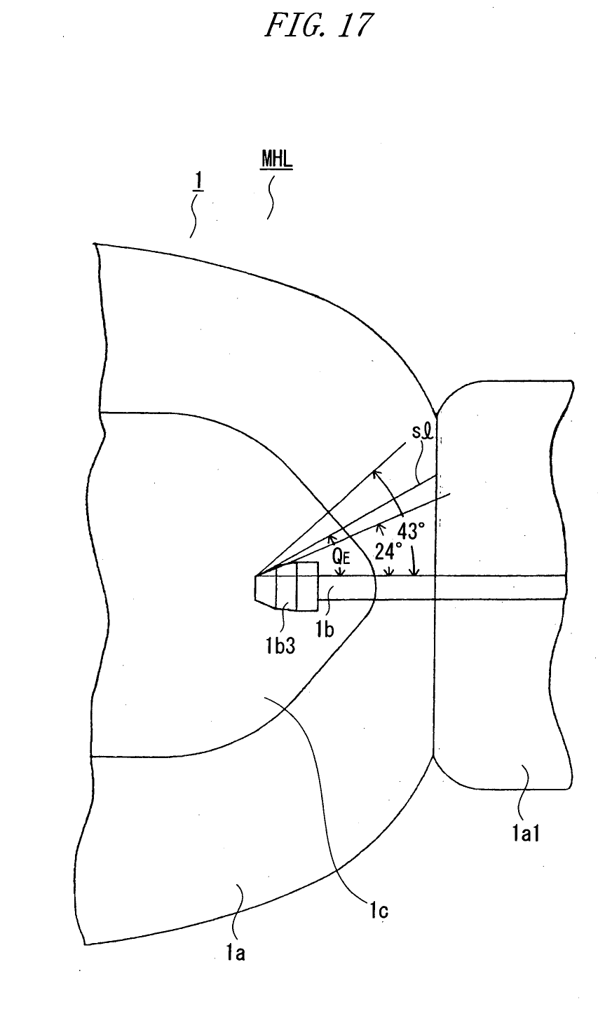

Now, with reference to FIGS. 16 and 17, modifications of the embodiment described in claim 6 will be described.

First, in a modification shown in FIG. 16, the tip end 1b1 of the electrode 1b has a semispherical shape. In such a case, assuming that the tip end of the electrode is planar, the electrode tip angle Q is measured as in the case shown in FIG. 14 and set to fall within the range of 24 to 43 degrees.

In a modification shown in FIG. 17, the electrode 1b has a large-diameter section 1b3 formed at the tip end thereof. In such a case, the electrode tip angle Q_{E} between a line s1 and the axis falls within the range of 24 to 43 degrees, the line s1 being the first, among lines extending from the shoulder of the tip end of the electrode, to intersect with the circumference of the large-diameter section 1b3 when being rotated toward the axis.

<Embodiment Described in Claim 7>

While the metal halide lamp according to this embodiment is apparently similar to that shown in FIG. 5, it is configured so that the atom density ratio A (%) of SiO₂ at the surface of the tip end of the electrode satisfies the formula (8).

### (EXAMPLE 6)

Discharge Vessel

The hermetic vessel 1a was made of quartz glass, and the bulb section 1a1 had an outer diameter of 6 mm and an inner diameter of 3 mm.

The electrodes 1b were made of tungsten, the shaft parts thereof had a diameter of 0.4 mm, and the distance between the electrodes was 4.2 mm.

Discharge Medium

The halides used were SCI₃, NaI and ZnI₂ in a relation of ScI₃−NaI−ZnI₂=1.2 mg.

Xenon gas was at 6 atmospheres.

Sealing was conducted in such a manner that, in a pressure box having an atmosphere kept at 3 atmospheres, xenon at −44° C. was sealed in the hermetic vessel 1a, the sealing parts made of quartz glass were heated and molten by a laser, and pinch sealing was performed with a pincher.

For the resulting metal halide lamp, the atom density ratio A of SiO₂ at the surface of the tip end of the electrode was 0.5%. This is because scattering of SiO₂ was adequately suppressed due to the high pressure sealing of xenon.

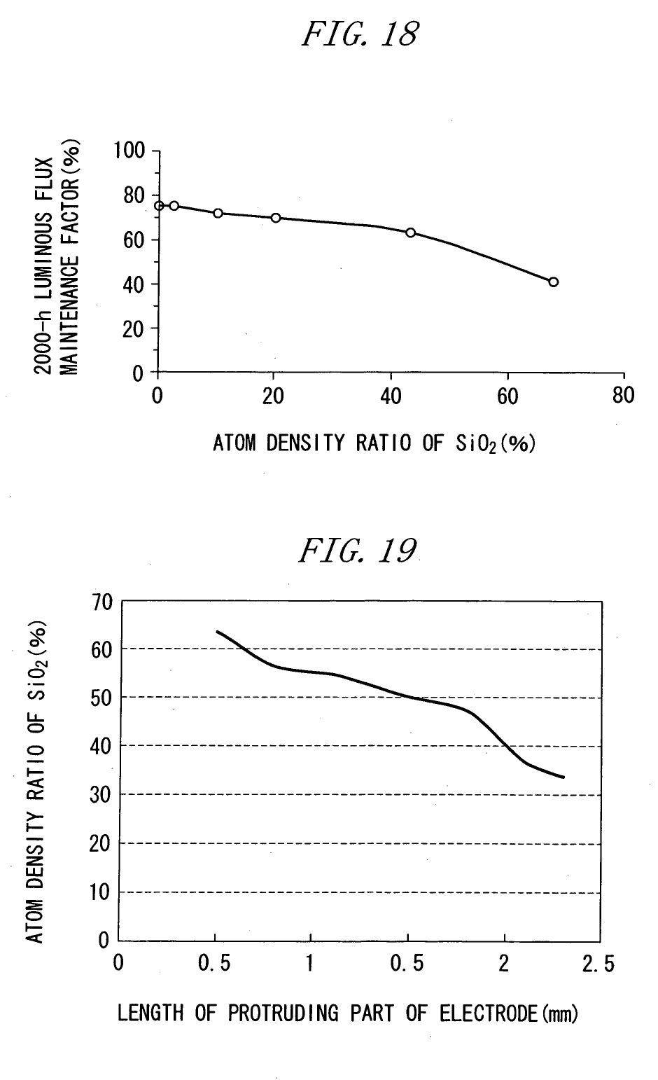

Now, with reference to FIG. 18, there will be described how the 2000-hour luminous flux maintenance factor varies when the atom density ratio A of SiO₂ at the surface of the tip end of the electrode of the mercury-free lamp is varied. In this drawing, the horizontal axis indicates the atom density ratio A (%) of SiO₂, and the vertical axis indicates the 2000-h luminous flux maintenance factor (%).

As can be seen from this drawing, when the atom density ratio A is lower than 43%, an improved luminous flux maintenance factor is provided.

### (EXAMPLE 7)

Discharge Vessel

The cross sectional area B of the sealing part 1a2 at the joint to the bulb section 1a1 was 5.34 mm² (diameter: 2.7 mm).

Discharge Medium

The halides used were ScI₃, NaI and ZnI₂ in a relation of ScI₃−NaI−ZnI₂=0.9 mg.

Xenon gas was at 13.5 atmospheres.

The other points were the same as in Example 6.

<Embodiment Described in Claim 8>

This embodiment will be described with reference to FIG. 19. In this drawing, the horizontal axis indicates the length (mm) of the protruding part of the electrode, and the vertical axis indicates the atom density ratio (%) of SiO₂ at the surface of the tip end of the electrode. This graph is made in the following manner. That is, quartz glass tubes having electrodes inserted therein are heated at portions to be sealed in an N₂ atmosphere to make the portions molten, and then the molten portions are sealed with a pincher, thereby providing a plurality of test pieces with the electrodes having different protruding lengths. Then, the atom density ratio of SiO₂ at the surface of the tip end of the electrodes is measured for the test pieces, and the measurements are used to plot the graph.

As can be seen from this drawing, if no particular means to reduce the atom density ratio of SiO₂ is used, when the length of the protruding part of the electrode is 1.9 mm or less, the atom density ratio is higher than 43% for most test pieces. In such a case, measures described concerning the embodiment of claim 7 may be selectively used.

<Another Example of Embodiments Described in Claims 1 to 9>

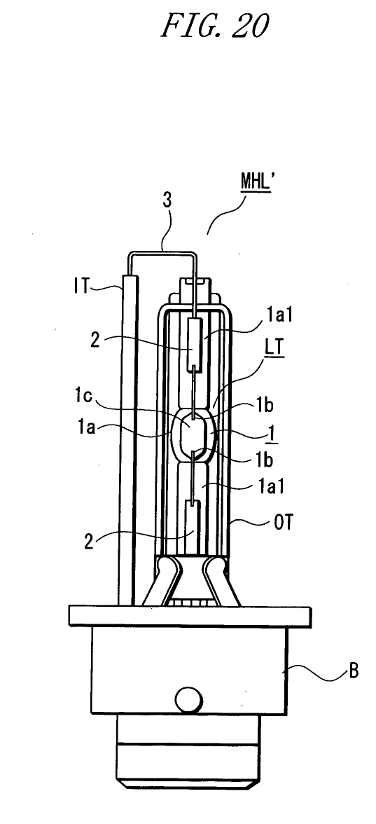

Another embodiment will be described with reference to FIG. 20. According to this embodiment, a metal halide lamp similar to that shown in FIG. 5 is mounted on an automotive headlamp apparatus. That is, the metal halide lamp (MHL′) comprises a light-emitting tube (LT), an outer jacket (OT), a cap (B) and an insulation tube (IT).

The light-emitting tube (LT) is configured the same as the metal halide lamp (MHL′) shown in FIG. 5. The parts same as those in FIG. 5 are assigned the same reference numerals, and the descriptions thereof are omitted.

The outer jacket (OT) can block the ultraviolet rays. It houses the light-emitting tube (LT) therein and is fixed to the sealing parts (1a1) at the both ends. However, it is not hermetically sealed but communicated with the outside air.

The cap (B) serves both to support the light-emitting tube (LT) and the outer jacket (OT) and to electrically interconnect the pair of electrodes (1b), (1b) of the light-emitting tube (LT). That is, one of the sealing parts (1a1) of the light-emitting tube (LT) is secured to the cap (B), and an external lead wire (3) drawn from the other sealing part extends parallel to the outer jacket (OT) and then is introduced into the cap (B) and connected to a terminal (not shown)

The insulation tube (IT) covers the external lead wire (3).

<Embodiment Described in Claim 10>

This embodiment will be described with reference to FIG. 20. In this drawing, a metal halide lamp lighting device comprises a lighting circuit (OC) and a metal halide lamp (MHL).

The lighting circuit (OC) comprises a direct-current power supply (11), a chopper (12), control means (13), lamp current detecting means (14), lamp voltage detecting means (15), an igniter (16) and a full-bridge inverter (17).

The direct-current power supply (11) is to supply a direct current power to the chopper (12) described later and may be a battery or rectified direct-current power supply. In the automotive application, a battery is typically used. Alternatively, it may be a rectified direct-current power supply that rectifies an alternating current. In any case, smoothing can be conducted with an electrolytic capacitor (11a) connected in parallel as required.

The chopper (12) is a DC/DC converter circuit that converts a direct-current voltage applied by the direct-current power supply (11) into a direct-current voltage of a required value, and determines the value of the output voltage to be applied to the metal halide lamp (MHL) through the full-bridge inverter (17) described later. If the voltage of the direct-current power supply is lower than the required output voltage, a booster chopper is used. On the other hand, if the voltage is higher than the required output voltage, a step-down chopper is used.

The control means (13) incorporates a microcomputer having a programmed temporal control pattern and controls the chopper (12). For example, the control means (13) controls the chopper (12) in such a manner that, immediately after the metal halide lamp is turned on, a lamp current three or more times higher than a rated lamp current is flowed from the chopper (12) to the metal halide lamp (MHL) via the full-bridge inverter (17), and then with the lapse of time, the lamp current is gradually reduced to the rated lamp current. Furthermore, the control means (13) receives feedback of detection signals associated with the lamp current and lamp voltage as described later, and thus, generates a constant power control signal to perform constant power control on the chopper (12).

The lamp current detecting means (14) is inserted in series with the lamp via the full-bridge inverter (17) and detects a current corresponding to the lamp current to provide a control input to the control means (13).

Similarly, the lamp voltage detecting means (15) is connected parallel to the lamp via the full-bridge inverter (17) and detects a voltage corresponding to the lamp voltage to provide a control input to the control means (13).

The igniter (16) is interposed between the full-bridge inverter (17) and the metal halide lamp (MHL) and configured to apply a starting pulse voltage on the order of 20 kV to the metal halide lamp (MHL) when turning on the lamp.

The full-bridge inverter (17) comprises a bridge circuit (17a) consisting of four MOSFETs (Q1), (Q2), (Q3) and (Q4), a gate drive circuit (17b) that alternately switches between the MOSFETs (Q1) and (Q3) and the MOSFETs (Q2) and (Q4) in the bridge circuit (17a), and a polarity inverting circuit (17c). The full-bridge inverter (17) converts the direct current voltage from the chopper (12) into a rectangular low-frequency alternating current voltage by the switching and applies the resulting voltage to the metal halide lamp (MHL) to turn on the lamp with the low-frequency alternating current.

If the metal halide lamp (MHL) is turned on with the rectangular low-frequency alternating current by the lighting circuit (OC) in this way, the metal halide lamp produces a required luminous flux immediately after it is turned on. Thus, 25% of the rated luminous flux can be attained 1 second after the power-on and 80% of the rated luminous flux can be attained 4 seconds after the power-on, which are requirements of the automotive headlamp.

<Embodiment Described in Claim 12>

This embodiment will be described with reference to FIG. 8. In this drawing, an automotive headlamp apparatus (HL) comprises an automotive headlamp apparatus main unit (21), a pair of lighting circuits (OC) and a pair of metal halide lamps (MHL′).

The automotive headlamp apparatus main unit (21) comprises a front transparent panel (21a), reflectors (21b), (21c), a lamp socket (21d) and a fixture (21e).

The front transparent panel (21a) is contoured to the shape of the outer surface of the automobile and has required optical means, for example, a prism.

Each of the reflectors (21b), (21c) is provided for each metal halide lamp (MHL′) and configured to provide required light distribution characteristics.

The lamp socket (21d) is connected to an output terminal of the lighting circuit (OC) and is mounted in a cap (21d) of the metal halide lamp (MHL′).

The fixture (21e) is means for fixing the automotive headlamp apparatus main unit (21) to the automobile at a predetermined position.

The metal halide lamp (MHL′) has the configuration described in claim 5 shown in FIG. 20. The lamp socket (21d) is mounted in the cap and connected thereto.

In this way, the two-bulb metal halide lamp (MHL′) is mounted in the automotive headlamp apparatus main unit (21), resulting in the four-bulb automotive headlamp apparatus (HL) The light emitting parts of each metal halide lamp (MHL′) are located generally at focal points of the reflectors (21b), (21c) of the automotive headlamp apparatus main unit (21).

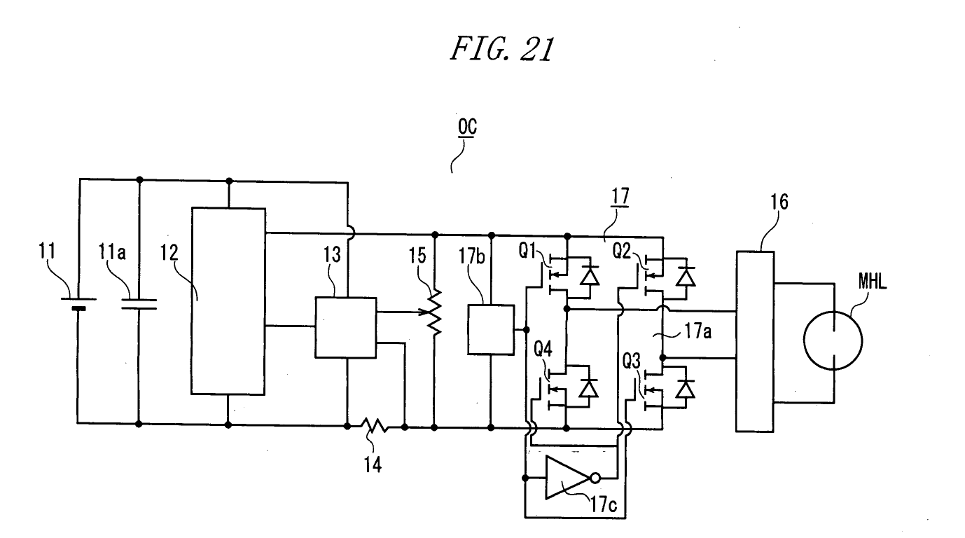

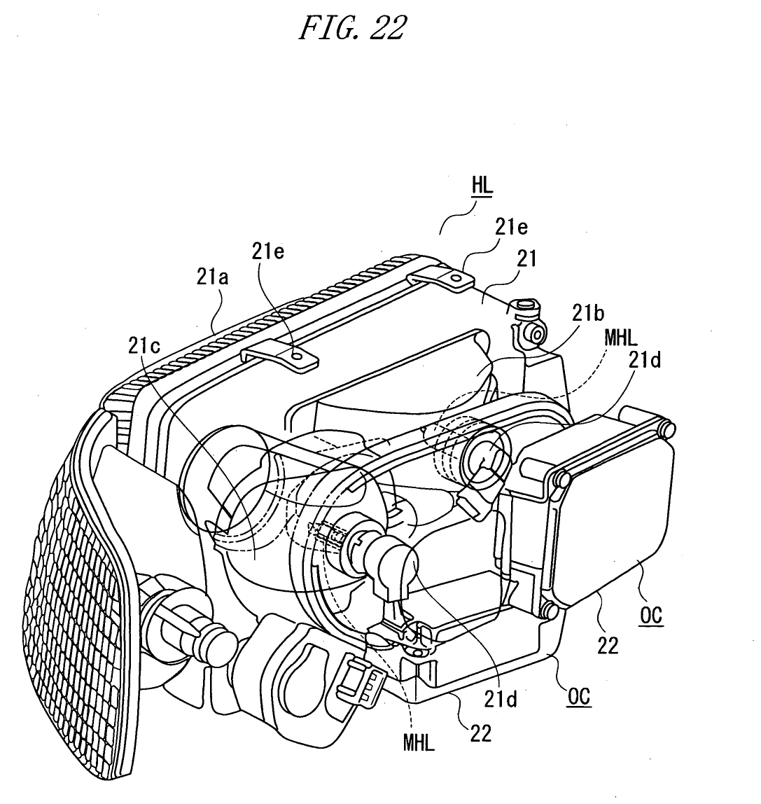

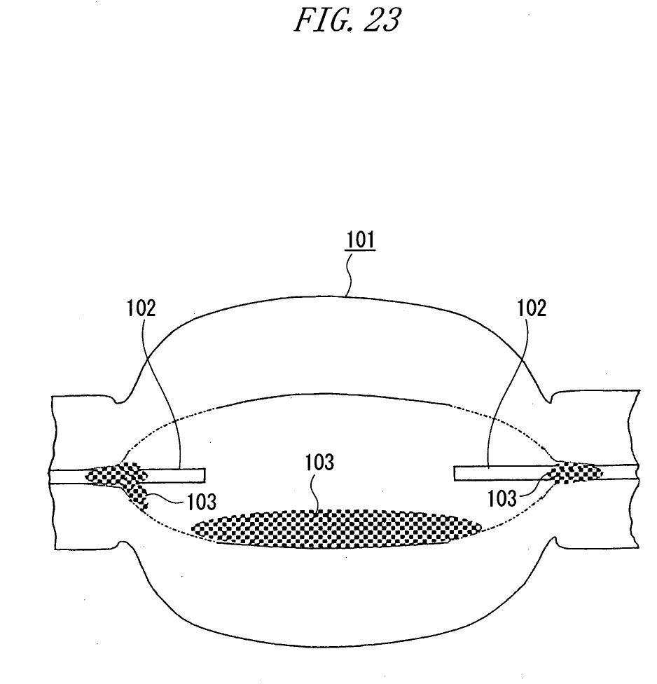

The lighting circuits (OC), which have the circuit arrangement shown in FIG. 21, are housed in metallic vessels (22) and energize the respective metal halide lamps (MHL′) to turn them on.

### INDUSTRIAL APPLICABILITY

According to the embodiment described in claim 1, there is provided a metal halide lamp comprising: a discharge vessel having an inner volume of C (cc); and a discharge medium containing xenon gas at 3 atmospheres or higher, a halide of sodium Na, and at least one of halides of scandium Sc and rare earth metals, the melting point of the halides being T (K), wherein the metal halide lamp is kept on with a lamp power of 50 W or lower in a stable state, and the formula (1) is satisfied:
(H/C)×[R/(T/500)⁶]<3.11 (1),
where the amount of the halide deposited on the electrodes is H (mg), and the ratio of a maximum lamp power at the start of lighting to the lamp power in the stable state is R, whereby mercury is substantially eliminated from the lamp out of consideration to the environment, a rapid rising of luminous flux is achieved, and the instantaneous intense light emission within 2 seconds after the lamp is turned on is suppressed.

According to the embodiment described in claim 2, there is provided a metal halide lamp comprising a discharge vessel and a discharge medium, wherein the metal halide lamp is kept on with a lamp power of 50 W or lower in a stable state, a lamp power 2.2 or more times higher than the lamp power in the stable state is supplied to the lamp during a period of 10 seconds after the lamp is turned on, 60% or more of the luminous flux in the stable state is achieved 4 seconds after the lamp is turned on, and the formula (2) is satisfied:
5<(L_{A-H})³×C_{T}/B_{W}<28 (2),
where the lamp power in the stable state is B_{W} (W), a minimum length between a point in an arc having a maximum luminance and a pool of the discharge medium in the liquid phase is L_{A-H} (mm), and the mass of the discharge space section of the hermetic vessel is C_{T} (mg), whereby mercury is substantially eliminated from the lamp out of consideration to the environment, and the rising of luminous flux is remarkably improved.

According to the embodiment described in claim 3, since the electrodes each have an average diameter of C_{E} (mm) in a section embedded in the hermetic vessel and have a maximum-diameter section in a part protruding into the discharge space, the average diameter of the protruding part is D_{E} (mm), and the formulas (3) and (4) are satisfied:
C_{E<D}_{E} (3), and
D_{E}−C_{E}>0.05 (4)
there is provided a metal halide lamp having a rapid rising of luminous flux and improved in efficiency and life.

According to the embodiment described in claim 4, since the maximum diameter of the part of each electrode protruding into the discharge space is B_{E} (mm), the average diameter for the distal 10% thereof is A_{E} (mm), and the formula (5) is satisfied:
A_{E}<B_{E} (5),
there is provided a metal halide lamp in which displacement of a cathode spot is suppressed and the light distribution characteristic is prevented from fluctuating.

According to the embodiment described in claim 5, since the electrodes each have an average diameter of C_{E} (mm) in a section embedded in the hermetic vessel, the maximum diameter of the part of each of the paired electrodes protruding into the discharge space is B_{E} (mm), the average diameter for the distal 10% thereof is A_{E} (mm), the average diameter of the protruding part being D_{E} (mm), and the formulas (3) and (6) are satisfied:
C_{E}<D_{E} (3), and
A_{E}<D_{E}<B_{E} (6),
there is provided a metal halide lamp in which displacement of a cathode spot is suppressed and the light distribution characteristic is prevented from fluctuating.

According to the embodiment described in claim 6, since each electrode has a large-diameter section at a short distance from the tip end, and an angle Q_{E} (°) between the axis of the electrode and a line drawn from a shoulder of the tip end to pass through an outermost point of the large-diameter section satisfies the formula (7):
24≦Q_{E}≦43 (7),
there is provided a metal halide lamp in which displacement of a cathode spot is suppressed and the light distribution characteristic is prevented from fluctuating.

According to the embodiment described in claim 7, there is provided a metal halide lamp suitable for the automotive headlamp comprising: a discharge vessel for which the atom density ratio A (%) of SiO₂ at the surface of the tip ends of the electrodes satisfies the formula (8):
2.5<A<43 (8); and
a discharge medium containing xenon gas at 3 atmospheres or higher and at least one of halides of sodium Na, scandium Sc and a rare earth metal, wherein the metal halide lamp is kept on with a lamp power of 50 W or lower in a stable state, a period in which a power 2.0 or more times higher than the lamp power in the stable state is input is provided immediately after the lamp is turned on, mercury is substantially eliminated from the lamp out of consideration to the environment, a rapid rising of luminous flux is achieved, wear of the electrodes is reduced, the occurrence of various defects due to the wear of the electrodes is suppressed, and thus, the metal halide lamp is improved in reliability.

According to the embodiment described in claim 8, since the electrodes each have a part protruding into the discharge space which has a length of 1.9 mm or less, there is provided a metal halide lamp which has a long life and is suitable for the automotive headlamp.

According to the embodiment described in claim 9, since the discharge medium contains one or more of halides of Mg, Co, Cr, Zn, Mn, Sb, Re, Ga, Sn, Fe, Al, Ti, Zr and Hf as a second halide, which serves as a medium for providing a lamp voltage, there is provided a metal halide lamp which can be adequately used for various applications including the automotive headlamp with using substantially no mercury, which applies a significant load to the environment.

According to the embodiment described in claim 10, since the second halide is a halide of Zn, which has a high vapor pressure, emits blue light and, therefore, is capable of color adjustment, there is provided an inexpensive and safe metal halide lamp.

According to the embodiment described in claim 11, there is provided a metal halide lamp lighting device having the advantages according to claims 1 to 10.

According to the embodiment described in claim 12, there is provided an automotive headlamp apparatus having the advantages according to claims 1 to 10.

1. A metal halide lamp, comprising:
a discharge vessel having a hermetic vessel which is fire resistant and translucent and has a discharge space therein, and a pair of electrodes provided at opposite ends of the discharge space in the hermetic vessel with facing each other at a distance of 5 mm or less, the inner volume of the hermetic vessel being C in terms of cc; and
a discharge medium substantially containing no mercury, sealed in the hermetic vessel, and containing xenon gas at 3 atmospheres or higher, a halide of sodium Na, and at least one of halides of scandium Sc and rare earth metals, the melting point of the halides being T in terms of K,
in a stable state, the metal halide lamp is kept on with a lamp power of 50 W or lower, and
the formula (1) is satisfied:
(H/C)×[R/(T/500)⁶]<3.11 (1),
where the amount of the halide deposited on the electrodes when the lamp is off is denoted by H in terms of mg, and the ratio of a maximum lamp power at the start of the lighting to the lamp power in the stable state is denoted by R.

2. A metal halide lamp, comprising:
a discharge vessel having a hermetic vessel which is fire resistant and translucent and has a discharge space therein, and a pair of electrodes sealed at opposite ends of the discharge space in the hermetic vessel with facing each other at a distance of 5 mm or less; and
a discharge medium substantially containing no mercury, sealed in the hermetic vessel, and containing a halide of a light-emitting metal and an inert gas, and in a stable state, the metal halide lamp is kept on with a lamp power of 50 W or lower,
during a period of 10 seconds after the lamp is turned on, a lamp power 2.2 or more times higher than the lamp power in the sable state is supplied to the lamp,
60% or more of the luminous flux in the stable state is achieved 4 seconds after the lamp is turned on, and
the formula (2) is satisfied:
5<(L_{A-H})³×C_{T}/B_{W}<28 (2),
where the lamp power in the stable state is B_{W} (W), a minimum length between a point in an arc having a maximum luminance and a pool of the discharge medium in the liquid phase is L_{A-H} (mm), and the mass of the discharge space section of the hermetic vessel is C_{T} (mg).

3. The metal halide lamp according to claim 2, wherein the paired electrodes each have an average diameter of C_{E} (mm) in a section embedded in the hermetic vessel and have a maximum-diameter section in a part protruding into the discharge space, the average diameter of the protruding part being D_{E} (mm), and the formulas (3) and (4) are satisfied:
C_{E}<D_{E} (3), and
D_{E}−C_{E}>0.05 (4).

4. The metal halide lamp according to claim 2, wherein the maximum diameter of the part of each of the paired electrodes protruding into the discharge space is B_{E} (mm), the average diameter for the distal 10% thereof is A_{E} (mm), and the formula (5) is satisfied:
A_{E}<B_{E} (5).

5. The metal halide lamp according to claim 2, wherein the paired electrodes each have an average diameter of CE (mm) in a section embedded in the hermetic vessel, the maximum diameter of the part of each of the paired electrodes protruding into the discharge space is B_{E} (mm), the average diameter for the distal 10% thereof is A_{E} (mm), the average diameter of the protruding part being D_{E} (mm), and the formulas (3) and (6) are satisfied:
C_{E}<D_{E} (3), and
A_{E}<D_{E}<B_{E} (6).

6. The metal halide lamp according to claim 2, wherein each of the paired electrodes has a large-diameter section at a short distance from the tip end, and an angle Q_{E} (°) between the axis of the electrode and a line drawn from a shoulder of the tip end to pass through an outermost point of the large-diameter section satisfies the formula (7):
24≦Q_{E}≦43 (7).

7. A metal halide lamp, comprising:
a discharge vessel having a hermetic vessel in which is made of quartz glass and has a discharge space therein, and a pair of electrodes provided at opposite ends of the discharge space in the hermetic vessel with facing each other at a distance of 5 mm or less, the atom density ratio A (%) of SiO₂ at the surface of the tip ends of the electrodes satisfying the formula (8):
2.5<A<43 (8),
a discharge medium substantially containing no mercury, sealed in the hermetic vessel, and containing xenon gas at 3 atmospheres or higher and at least one of halides of sodium Na, scandium Sc and a rare earth metal,
in a stable state, the metal halide lamp is kept on with a lamp power of 50 W or lower, and
a period in which a power two or more times higher than the lamp power in the stable state is input is provided immediately after the lamp is turned on.

8. The metal halide lamp according to claim 7, wherein the paired electrodes each have a part protruding into the discharge space which has a length of 1.9 mm or less.

9. The metal halide lamp according to any one of claims 1 to 8, wherein the discharge medium contains a halide of a light-emitting metal as a first halide, and one or more of halides of Mg, Co, Cr, Zn, Mn, Sb, Re, Ga, Sn, Fe, Al, Ti, Zr and Hf as a second halide.

10. The metal halide lamp according to claim 9, wherein the second halide is a halide of Zn.

11. A metal halide lamp lighting device, comprising:
a metal halide lamp according to any one of claims 1 to 8; and
a lighting circuit in which a maximum lamp power at the start of lighting within 4 seconds after the metal halide lamp is turned on is two to four times higher than a lamp power in a stable state.

12. An automotive headlamp apparatus, comprising:
an automotive headlamp apparatus main unit;
a metal halide lamp according to any one of claims 1 to 8 which is installed in the automotive headlamp apparatus with the axis of a discharge vessel thereof being aligned with an optical axis of the automotive headlamp apparatus main unit; and
a lighting circuit in which a maximum lamp power at the start of lighting within 4 seconds after the metal halide lamp is turned on is two to four times higher than a lamp power in a stable state.
